(19) United States
(12) Patent Application Publication
(10) Pub. No.: US 2023/0318105 A1
(43) Pub. Date: Oct. 5, 2023

(54) BATTERY PACK

(71) Applicant: MILWAUKEE ELECTRIC TOOL CORPORATION, Brookfield, WI (US)

(72) Inventors: Keith Boulanger, Twin Lakes, WI (US); Ryan B. Jipp, Brookfield, WI (US); Kyle C. Fassbender, Brookfield, WI (US); Matthew R. Polakowski, Greenfield, WI (US); Nicholas A. Sanchez, Milwaukee, WI (US); Richard M. Sebzda, Wauwatosa, WI (US)

(21) Appl. No.: 18/194,537

(22) Filed: Mar. 31, 2023

Related U.S. Application Data
(60) Provisional application No. 63/325,938, filed on Mar. 31, 2022.
(60) Provisional application No. 63/339,671, filed on May 9, 2022.

(51) Int. Cl. H01M 50/213; H01M 50/247

(52) U.S. Cl. CPC H01M 50/213; H01M 50/247

(57) ABSTRACT

A battery pack includes an outer housing and a plurality of pouch cells arranged within the outer housing. Each of the plurality of pouch cells has a first cell end, a second cell end, and a cell side surface provided between the first cell end and the second cell end. The cell side surface includes a first face, a second face, and a third face. Each of the plurality of pouch cells has a thickness in a first direction extending between the first cell end and the second cell end and has a two-dimensional projection in a plane that is orthogonal to the first direction.

### CROSS-REFERENCE TO RELATED APPLICATIONS

This application claims priority to U.S. Provisional Application No. 63/325,938, filed Mar. 31, 2022, and U.S. Provisional Application No. 63/339,671, filed May 9, 2022, which are hereby incorporated by reference herein.

### FIELD

The present disclosure relates to battery packs, and more particularly, to battery packs for power tools.

### BACKGROUND

A battery pack may be used to power one or more electric motors. The battery pack may include cylindrical cells or pouch cells, and the electric motor may be used for various purposes, including driving a power tool.

### SUMMARY

A battery pack includes an outer housing and a plurality of pouch cells arranged within the outer housing. Each of the plurality of pouch cells has a first cell end, a second cell end, and a cell side surface provided between the first cell end and the second cell end, wherein the cell side surface includes a first face, a second face, and a third face. Each of the plurality of pouch cells has a thickness in a first direction extending between the first cell end and the second cell end and has a two-dimensional projection in a plane that is orthogonal to the first direction. At least one of the plurality of pouch cells has a two-dimensional projection that is both noncircular and nonrectangular. The plurality of pouch cells are arranged in a first stack, a second stack, and a third stack. The first stack has a first longitudinal axis, the second stack has a second longitudinal axis, and the third stack has a third longitudinal axis. The second longitudinal axis is parallel to the third longitudinal axis, and the first longitudinal axis is perpendicular to both the second longitudinal axis and the third longitudinal axis.

The two-dimensional projection may define an outer boundary of the cell side surface.

The two-dimensional projection may have a plurality of flattened edges.

Each of the pouch cells may include a two-dimensional projection that is a trilobal shape.

The plurality of the pouch cells may be arranged in at least one stack having a uniformly prismatic structure along the first direction.

Each of the plurality of pouch cells may include a first tab and a second tab.

The first tab may be provided on the first face and the second tab may be provided on the second face.

The third face may not include a tab.

At least a portion of the outer housing may be configured to match the shape of the uniformly prismatic structure.

The outer housing may include a male protrusion that is configured to be received within a female battery receptacle of a power tool.

The battery pack may include first pouch cell and a second pouch cell, each having a uniformly prismatic structure and a longitudinal axis. The longitudinal axis of the first pouch cell may be parallel to the longitudinal axis of the second pouch cell. The pouch cells may be oriented such that one of the faces of the first pouch cell is adjacent to one of the faces of the second pouch cell.

The battery pack may include a first pouch cell and a second pouch cell, each having a uniformly prismatic structure and a longitudinal axis, wherein the pouch cells are oriented such that the shortest distance between the longitudinal axes of the first pouch cell and the second pouch cell passes through one of the faces of the first pouch cell and also passes through one of the faces of the second pouch cell.

The battery pack may include a first stack of pouch cells having a uniformly prismatic structure and a second stack of pouch cells having a uniformly prismatic structure, wherein each of the stacks includes a first stack face, a second stack face, and a third stack face. Each of the pouch cells in the first stack may share a first common longitudinal axis. Each of the pouch cells in the second stack may share a second common longitudinal axis. The stacks of pouch cells may be oriented such that the shortest distance between the first common longitudinal axis and the second common longitudinal axis passes through one of the stack faces of the first stack and also passes through one of the stack faces of the second stack.

Each of the pouch cells may include a two-dimensional projection that includes at least five sides.

Each of the pouch cells may include a two-dimensional projection that includes at least six sides.

Each of the pouch cells may include a two-dimensional projection that includes at least seven sides.

A battery pack may include a cylindrical pouch cell housed in a cell can having a longitudinal axis, wherein the cell can is formed as a first cell can piece and a second cell can piece. The first cell can piece has a first cell can end and the second cell can piece has a second cell can end. The first cell can piece is crimped to the second cell can piece at a crimping location. The crimping location is located between the first cell can end and the second cell can end. The crimping location extends circumferentially around the cylindrical pouch cell and is provided with a separator and a gasket.

The crimping location may be at the center of the cell can as measured along the longitudinal axis of the cell can.

The pouch cell may include tabs. The cell can may include at least one slot in one of the first cell can end and the second cell can end through which the tabs protrude.

A battery pack may include a battery cell having an elongated prismatic structure. The battery cell includes a first end and a second end, one of the ends having electrical connections. The battery cell includes a body portion disposed between the first end and the second end. The body portion includes a cell side surface that extends between the first end and the second end. The battery cell includes a longitudinal axis that extends between the first end and the second end. The cell side surface includes a plurality of flattened faces. The cell side surface includes a plurality of corners.

A plurality of battery cells may be provided within the battery pack and arranged such that the shortest distance between the longitudinal axes of two adjacent battery cells passes through a face of each of the two adjacent battery cells.

According to some embodiments, a power tool system comprises a first battery pack having a first plurality of cylindrical cells, each of the first plurality of cylindrical cells having first dimensions. The power tool system may further comprise a second battery pack having a second plurality of cylindrical cells, each of the second plurality of cylindrical cells having second dimensions, at least one of the second dimensions being different from a corresponding one of the first dimensions. The power tool system may further comprise a third battery pack having a third plurality of cylindrical cells, each of the third plurality of cylindrical cells having third dimensions, at least one of the third dimensions being different from a corresponding one of the first dimensions and a corresponding one of the second dimensions. The power tool system may further comprise a fourth battery pack having a fourth plurality of pouch cells, each of the fourth plurality of pouch cells having fourth dimensions, at least one of the fourth dimensions being different from a corresponding one of the first dimensions, a corresponding one of the second dimensions, and a corresponding one of the third dimensions. The first battery pack, the second battery pack, the third battery pack, and the fourth battery pack may be exchangeably couplable to a power tool.

In some embodiments, each cell of each of the first, second, and third pluralities of cylindrical cells may have a diameter of between 15 mm and 55 mm.

In some embodiments, each cell of each of the first, second, and third pluralities of cylindrical cells may have a length of between 60 mm and 80 mm.

In some embodiments, each cell of each of the first, second, and third pluralities of cylindrical cells may have an energy density of at least 500 Wh/L.

In some embodiments, each cell of each of the first, second, and third pluralities of cylindrical cells may have an energy density of at least 580 Wh/L.

In some embodiments, the first battery pack may have a first interior volume, the second battery pack may have a second interior volume different from the first interior volume, the third battery pack may have a third interior volume different from the first interior volume and the second interior volume, and the fourth battery pack may have a fourth interior volume different from the first interior volume, the second interior volume, and the third interior volume.

In some embodiments, each cell of the first plurality of cylindrical cells may have a diameter of 18 mm and a length of 65 mm.

In some embodiments, each cell of the second plurality of cylindrical cells may have a diameter of 21 mm and a length of 70 mm.

In some embodiments, the first battery pack may have a first shape, the second battery pack may have a second shape, the third battery pack may have a third shape, and the first shape, the second shape, and the third shape may be different from each other.

In some embodiments, a length of each of the first battery pack, the second battery pack, the third battery pack, and the fourth battery pack may be different from the length of each of the other battery packs.

In some embodiments, a height of each of the first battery pack, the second battery pack, the third battery pack, and the fourth battery pack may be different from the height of each of the other battery packs.

In some embodiments, each of the first battery pack, the second battery pack, the third battery pack, and the fourth battery pack may have a different battery pack capacity.

In some embodiments, each of the first battery pack, the second battery pack, the third battery pack, and the fourth battery pack may have a different energy density.

According to some embodiments, a power tool system comprises a first battery pack having a first battery connection interface couplable to a power tool a first plurality of cylindrical cells of a first type. The power tool system may further comprise a second battery pack having a second battery connection interface couplable to the power tool and a second plurality of cylindrical cells of a second type, the second type being different from the first type. The power tool system may further comprise a third battery pack having a third battery connection interface couplable to the power tool and a third plurality of cylindrical cells of a third type, the third type being different from the first type and the second type.

In some embodiments, the first battery connection interface, the second connection interface, and the third connection interface may be identical.

In some embodiments, each of the first type, second type, and third type may include a diameter, and a diameter of each of the first, second, and third pluralities of cylindrical cells may be between 15 mm and 55 mm.

In some embodiments, each of the first type, second type, and third type may include a length, and a length of each of the first, second, and third pluralities of cylindrical cells may be between 60 mm and 80 mm.

In some embodiments, the first battery pack may have a first battery pack capacity, the second battery pack may have a second battery pack capacity that is different from the first battery pack capacity, and the third battery pack may have a third battery pack capacity that is different from the first battery pack capacity and the second battery pack capacity.

In some embodiments, the first battery pack may have a first battery pack energy density, the second battery pack may have a second battery pack energy density that is different from the first battery pack energy density, and the third battery pack may have a third battery pack energy density that is different from the first battery pack energy density and the second battery pack energy density.

In some embodiments, each of the first battery pack energy density, the second battery pack energy density, and the third battery pack energy density may be at least 185 Wh/L.

According to some embodiments, a battery pack comprises a battery pack housing having an internal volume defined therein and a plurality of cylindrical battery cells disposed in the internal volume and electrically connected to each other to provide power to a power tool. The battery pack may have a battery pack energy density of at least 213 Wh/L.

In some embodiments, the battery pack may have an energy density of at least 222 Wh/L.

In some embodiments, the battery pack may have an energy density of at least 233 Wh/L.

In some embodiments, the battery pack may have an energy density of at least 241 Wh/L.

In some embodiments, the battery pack may have an energy density of at least 250 Wh/L.

In some embodiments, the battery pack may have an energy density of at least 257 Wh/L.

According to some embodiments, a battery pack comprises a battery pack housing, a battery connection interface disposed on the battery pack housing, and a first battery cell having a first capacity, the first battery cell electrically connected to the battery connection interface. The battery pack may further comprise a second battery cell having a second capacity, the second battery cell electrically connected to the battery connection interface. The first capacity may be different from the second capacity.

In some embodiments, the battery pack may further comprise a third battery cell having a third capacity, the third battery cell electrically connected to the battery connection interface. The third capacity may be different from the first capacity and the second capacity.

In some embodiments, the first battery cell, the second battery cell, and the third battery cell may have different shapes.

In some embodiments, the first battery cell, the second battery cell, and the third battery cell may have different lengths.

In some embodiments, the first battery cell and the second battery cell may be cylindrical battery cells. The first battery cell and the second battery cell may have different diameters.

In some embodiments, the first battery cell may be a cylindrical battery cell and the second battery cell may be a pouch cell.

In some embodiments, the first battery cell and the second battery cell may be electrically connected in series.

Other features and aspects of the disclosure will become apparent by consideration of the following detailed description and accompanying drawings.

### BRIEF DESCRIPTION OF THE DRAWINGS

FIG. 1A is a perspective view of a battery pack according to one embodiment.

FIG. 1B is a perspective view of a battery pack according to another embodiment.

FIG. 1C is a perspective view of a battery pack according to another embodiment.

FIG. 2 is a side-by-side comparison of various embodiments of battery packs.

FIG. 3A is a perspective view of a battery pack according to another embodiment.

FIG. 3B is a front view of the battery pack of FIG. 3A including a transparent outer housing.

FIG. 3C is a perspective view of the battery pack of FIG. 3A with the outer housing hidden in order to show an arrangement of battery cells within the battery pack.

FIG. 3D is a front view of the battery pack of FIG. 3A as compared to a larger battery pack.

FIG. 3E is a left side view of the battery pack of FIG. 3A as compared to a larger battery pack.

FIG. 4A is a side-by-side comparison of two different embodiments of battery packs.

FIG. 4B is a side-by-side comparison of two different embodiments of battery packs.

FIG. 4C is a side-by-side comparison of two different embodiments of battery packs.

FIG. 5A is a perspective view of a battery pack according to another embodiment.

FIG. 5B is a perspective view of the battery pack of FIG. 3A.

FIG. 5C is a perspective view of a battery pack according to another embodiment.

FIG. 6A is an embodiment of a battery pack coupled with a press tool.

FIG. 6B is an embodiment of a battery pack coupled with a drill.

FIG. 6C is an embodiment of a battery pack coupled with a circular saw.

FIG. 6D is an embodiment of a battery pack coupled with a rover light.

FIG. 6E is an embodiment of a battery pack coupled with a drill.

FIG. 7A is a perspective view of a battery pack according to another embodiment.

FIG. 7B is a front view of the battery pack of FIG. 7A including a transparent outer housing.

FIG. 7C is a perspective view of the battery pack of FIG. 7A with the outer housing hidden in order to show an arrangement of battery cells within the battery pack.

FIG. 8A is a perspective view of a battery pack according to another embodiment.

FIG. 8B is a front view of the battery pack of FIG. 8A including a transparent outer housing.

FIG. 8C is a perspective view of the battery pack of FIG. 8A with the outer housing hidden in order to show an arrangement of battery cells within the battery pack.

FIG. 9A is a perspective view of a battery pack according to another embodiment.

FIG. 9B is a front view of the battery pack of FIG. 9A including a transparent outer housing.

FIG. 9C is a perspective view of the battery pack of FIG. 9A with the outer housing hidden in order to show an arrangement of battery cells within the battery pack.

FIG. 10A is a perspective view of a battery pack according to another embodiment.

FIG. 10B is a front view of the battery pack of FIG. 10A including a transparent outer housing.

FIG. 10C is a perspective view of the battery pack of FIG. 10A with the outer housing hidden in order to show an arrangement of battery cells housed within an inner housing of the battery pack.

FIG. 10D is a perspective view of the battery pack of FIG. 10A with the outer housing hidden and the inner housing hidden in order to show an arrangement of battery cells within an inner housing of the battery pack.

FIG. 11A is a perspective view of a battery pack according to another embodiment.

FIG. 11B is a front view of the battery pack of FIG. 11A including a transparent outer housing.

FIG. 11C is perspective view of the battery pack of FIG. 11A with the outer housing hidden in order to show an arrangement of battery cells housed within an inner housing of the battery pack.

FIG. 11D is a perspective view of the battery pack of FIG. 11A with the outer housing hidden and the inner housing hidden in order to show an arrangement of battery cells within an inner housing of the battery pack.

FIG. 12 is a side-by-side comparison of two different embodiments of battery cells.

FIG. 13A is a perspective view of a battery pack according to another embodiment.

FIG. 13B is a perspective view of a battery pack according to another embodiment.

FIG. 13C is a front view of the battery pack of FIG. 13A including a transparent outer housing.

FIG. 13D is a front view of the battery pack of FIG. 13B including a transparent outer housing.

FIG. 14A is battery pack according to another embodiment.

FIG. 14B is a battery pack according to another embodiment.

FIG. 15A is an end of a battery cell having a crimp at the end of the battery cell.

FIG. 15B is an embodiment of a battery cell having a crimp disposed between two ends of the battery cell.

FIG. 15C is a front view of the battery cell of FIG. 15A.

FIG. 15D is a front view of the battery cell of FIG. 15B.

FIG. 15E is a perspective view of the battery cell of FIG. 15B.

FIG. 15F is a cross-section view of the battery cell of FIG. 15B.

FIG. 16A is a perspective view of a battery cell according to another embodiment.

FIG. 16B is a left side view of the battery cell of FIG. 16A.

FIG. 16C is an arrangement of the battery cells of FIG. 16A.

FIG. 16D is another arrangement of the battery cells of FIG. 16A.

FIG. 17A is perspective view of a battery cell according to another embodiment.

FIG. 17B is a top view of the battery cell of FIG. 17A.

FIG. 17C is a top view of a battery pack configured to house the battery cell of FIG. 17A.

FIG. 17D is a perspective view of a battery cell according to another embodiment.

FIG. 17E is a perspective view of a battery cell according to another embodiment.

FIG. 17F is a perspective view of battery cells according to another embodiment.

FIG. 18A is a top view of a stack of battery cells of FIG. 17A connected in parallel.

FIG. 18B is a top view of a stack of battery cells of FIG. 17A connected in series.

FIG. 18C is a top view of a connected row of battery cells of FIG. 17A.

FIG. 19 is a side-by-side comparison of a schematic of a battery cell produced by winding technology and a schematic of a battery cell produced by stacking technology.

FIG. 20A is a perspective view of a battery pack housing according to an embodiment.

FIG. 20B is a cross-section view of a battery pack including the battery pack housing of FIG. 20A according to an embodiment.

FIG. 20C is a cross-section view of a battery pack including the battery pack housing of FIG. 20A according to another embodiment.

FIG. 20D is a cross-section view of a battery pack including the battery pack housing of FIG. 20A according to another embodiment.

FIG. 20E is a cross-section view of a battery pack including the battery pack housing of FIG. 20A according to another embodiment.

FIG. 20F is a cross-section view of a battery pack including the battery pack housing of FIG. 20A according to another embodiment.

FIG. 21A is a perspective view of a battery pack housing according to another embodiment.

FIG. 21B is a cross-section view of a battery pack including the battery pack housing of FIG. 21A according to an embodiment.

FIG. 21C is a cross-section view of a battery pack including the battery pack housing of FIG. 21A according to another embodiment.

FIG. 21D is a cross-section view of a battery pack including the battery pack housing of FIG. 21A according to another embodiment.

FIG. 21E is a cross-section view of a battery pack including the battery pack housing of FIG. 21A according to another embodiment.

FIG. 21F is a cross-section view of a battery pack including the battery pack housing of FIG. 21A according to another embodiment.

FIG. 22A is a perspective view of a battery pack housing according to another embodiment.

FIG. 22B is a cross-section view of a battery pack including the battery pack housing of FIG. 22A according to an embodiment.

FIG. 22C is a cross-section view of a battery pack including the battery pack housing of FIG. 22A according to another embodiment.

FIG. 22D is a cross-section view of a battery pack including the battery pack housing of FIG. 22A according to another embodiment.

FIG. 22E is a cross-section view of a battery pack including the battery pack housing of FIG. 22A according to another embodiment.

FIG. 22F is a cross-section view of a battery pack including the battery pack housing of FIG. 22A according to another embodiment.

FIG. 22G is a graph showing volumetric energy density as a function of a number of rows in parallel for the battery packs of FIGS. 20B-20F, 21B-21F, and 22B-22F.

FIG. 22H is a graph showing pack capacity as a function of a number of rows in parallel for the battery packs of FIGS. 20B-20F, 21B-21F, and 22B-22F.

FIG. 23A is a perspective view of a battery pack housing according to another embodiment.

FIG. 23B is a cross-section view of a battery pack including the battery pack housing of FIG. 23A according to an embodiment.

FIG. 23C is a cross-section view of a battery pack including the battery pack housing of FIG. 23A according to another embodiment.

FIG. 23D is a cross-section view of a battery pack including the battery pack housing of FIG. 23A according to another embodiment.

FIG. 23E is a cross-section view of a battery pack including the battery pack housing of FIG. 23A according to another embodiment.

FIG. 23F is a cross-section view of a battery pack including the battery pack housing of FIG. 23A according to another embodiment.

FIG. 24A is a perspective view of a battery pack housing according to another embodiment.

FIG. 24B is a cross-section view of a battery pack including the battery pack housing of FIG. 24A according to an embodiment.

FIG. 24C is a cross-section view of a battery pack including the battery pack housing of FIG. 24A according to another embodiment.

FIG. 24D is a cross-section view of a battery pack including the battery pack housing of FIG. 24A according to another embodiment.

FIG. 24E is a cross-section view of a battery pack including the battery pack housing of FIG. 24A according to another embodiment.

FIG. 24F is a cross-section view of a battery pack including the battery pack housing of FIG. 24A according to another embodiment.

FIG. 25A is a perspective view of a battery pack housing according to another embodiment.

FIG. 25B is a cross-section view of a battery pack including the battery pack housing of FIG. 25A according to an embodiment.

FIG. 25C is a cross-section view of a battery pack including the battery pack housing of FIG. 25A according to another embodiment.

FIG. 25D is a cross-section view of a battery pack including the battery pack housing of FIG. 25A according to another embodiment.

FIG. 25E is a cross-section view of a battery pack including the battery pack housing of FIG. 25A according to another embodiment.

FIG. 25F is a cross-section view of a battery pack including the battery pack housing of FIG. 25A according to another embodiment.

FIG. 25G is a graph showing volumetric energy density as a function of a number of rows in parallel for the battery packs of FIGS. 23B-23F, 24B-24F, and 25B-25F.

FIG. 25H is a graph showing pack capacity as a function of a number of rows in parallel for the battery packs of FIGS. 23B-23F, 24B-24F, and 25B-25F.

FIG. 26A is a perspective view of a battery pack housing according to another embodiment.

FIG. 26B is a cross-section view of a battery pack including the battery pack housing of FIG. 26A according to an embodiment.

FIG. 26C is a cross-section view of a battery pack including the battery pack housing of FIG. 26A according to another embodiment.

FIG. 26D is a cross-section view of a battery pack including the battery pack housing of FIG. 26A according to another embodiment.

FIG. 26E is a cross-section view of a battery pack including the battery pack housing of FIG. 26A according to another embodiment.

FIG. 26F is a cross-section view of a battery pack including the battery pack housing of FIG. 26A according to another embodiment.

FIG. 27A is a perspective view of a battery pack housing according to another embodiment.

FIG. 27B is a cross-section view of a battery pack including the battery pack housing of FIG. 27A according to an embodiment.

FIG. 27C is a cross-section view of a battery pack including the battery pack housing of FIG. 27A according to another embodiment.

FIG. 27D is a cross-section view of a battery pack including the battery pack housing of FIG. 27A according to another embodiment.

FIG. 27E is a cross-section view of a battery pack including the battery pack housing of FIG. 27A according to another embodiment.

FIG. 27F is a cross-section view of a battery pack including the battery pack housing of FIG. 27A according to another embodiment.

FIG. 28A is a perspective view of a battery pack housing according to another embodiment.

FIG. 28B is a cross-section view of a battery pack including the battery pack housing of FIG. 28A according to an embodiment.

FIG. 28C is a cross-section view of a battery pack including the battery pack housing of FIG. 28A according to another embodiment.

FIG. 28D is a cross-section view of a battery pack including the battery pack housing of FIG. 28A according to another embodiment.

FIG. 28E is a cross-section view of a battery pack including the battery pack housing of FIG. 28A according to another embodiment.

FIG. 28F is a cross-section view of a battery pack including the battery pack housing of FIG. 28A according to another embodiment.

FIG. 28G is a graph showing volumetric energy density as a function of a number of rows in parallel for the battery packs of FIGS. 26B-26F, 27B-27F, and 28B-28F.

FIG. 28H is a graph showing pack capacity as a function of a number of rows in parallel for the battery packs of FIGS. 26B-26F, 27B-27F, and 28B-28F.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

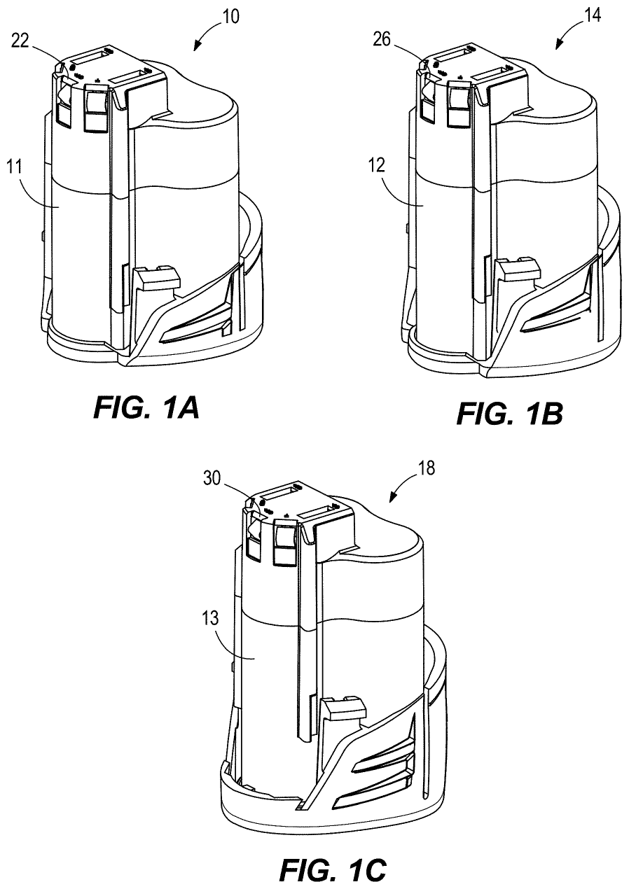

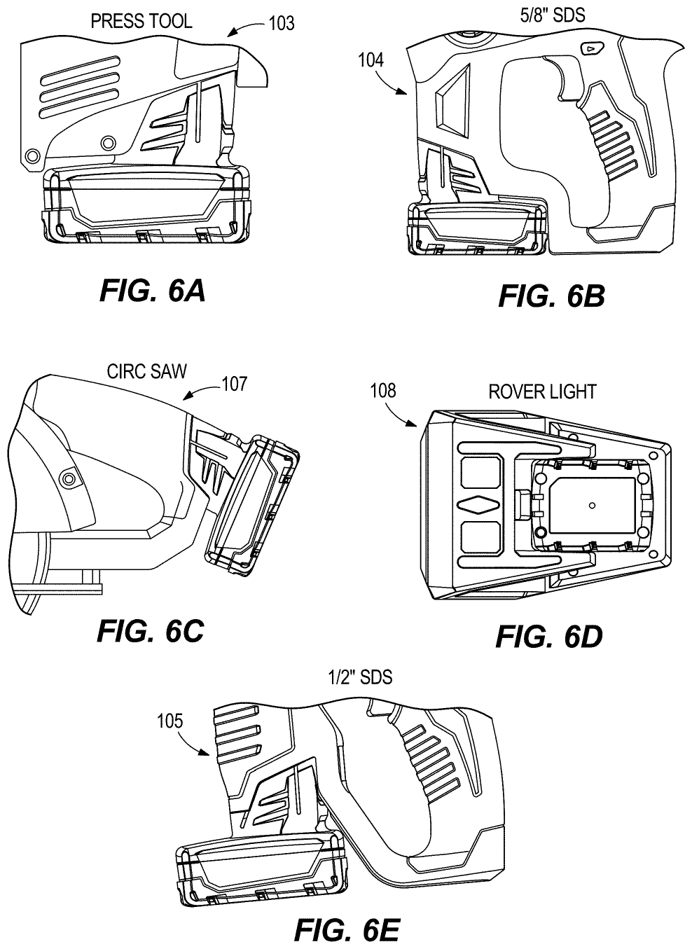

With reference to FIGS. 1A-1C, battery packs 10, 14, 18 include respective battery connection interfaces 22, 26, 30. The battery connection interfaces 22, 26, 30 are configured to interface with and electronically communicate with a corresponding receptacle that is provided, for example, on a power tool as shown in FIGS. 6A-6E. Although the embodiments of battery packs disclosed herein may differ in certain respects, each may include a battery connection interface that is configured to interface with receptacles in order to perform a variety of tasks, including selectively powering a plurality of different power tools. Each of the battery packs 10, 14, 18 respectively includes an outer housing 11, 12, 13. The outer housings 11, 12, 13 house and protect the internals (e.g., battery cells) of the battery packs 10, 14, 18.

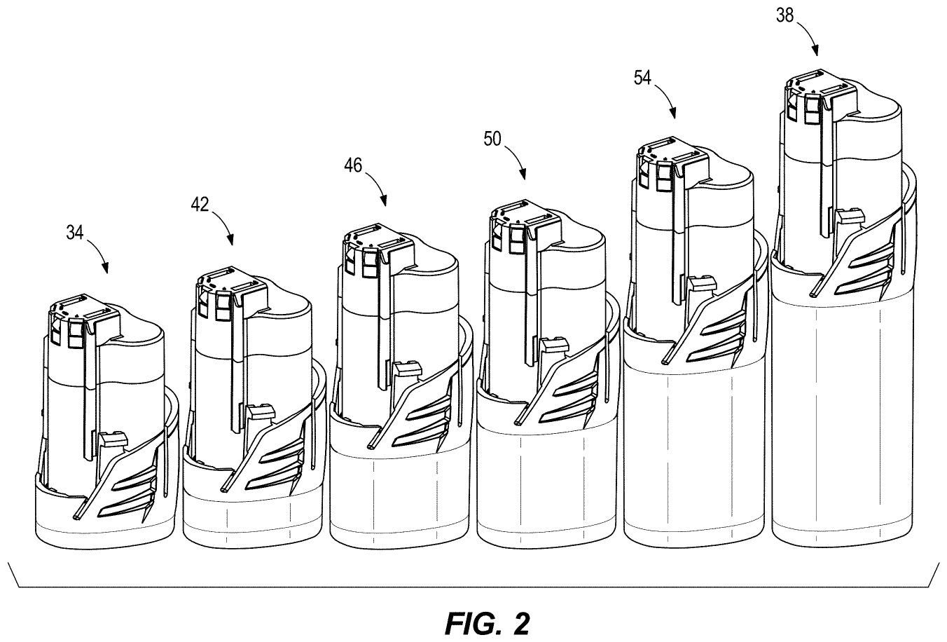

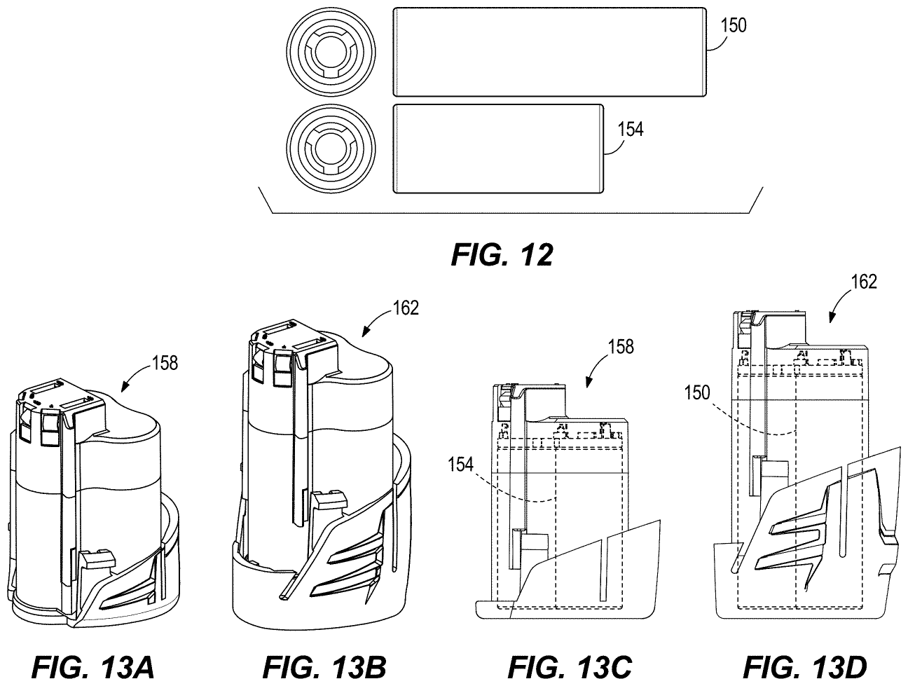

With reference to FIG. 2, a relatively short battery pack 34 may be provided. Alternatively, a relatively long battery pack 38 may be provided. Further, battery packs 42, 46, 50, 54 may be provided that are longer than the battery pack 34 and shorter than the battery pack 38. Additionally, battery packs may be provided that are shorter than the battery pack 34. Battery packs may also be provided that are longer than the battery pack 38. The various battery packs 34, 38, 42, 46, 50, 54 may have different amp-hour (“A-h” or “Ah”) capacities. The battery packs 34, 38, 42, 46, 50, 54 may have capacities that range from 2.55 A-h to 6.0 A-h or that are less than 2.55 A-h or greater than 6.0 A-h. The battery packs 34, 38, 42, 46, 50, 54 include battery cells that may be custom-made to have different lengths or other dimensions (e.g. length, width, and height) (see FIG. 12).

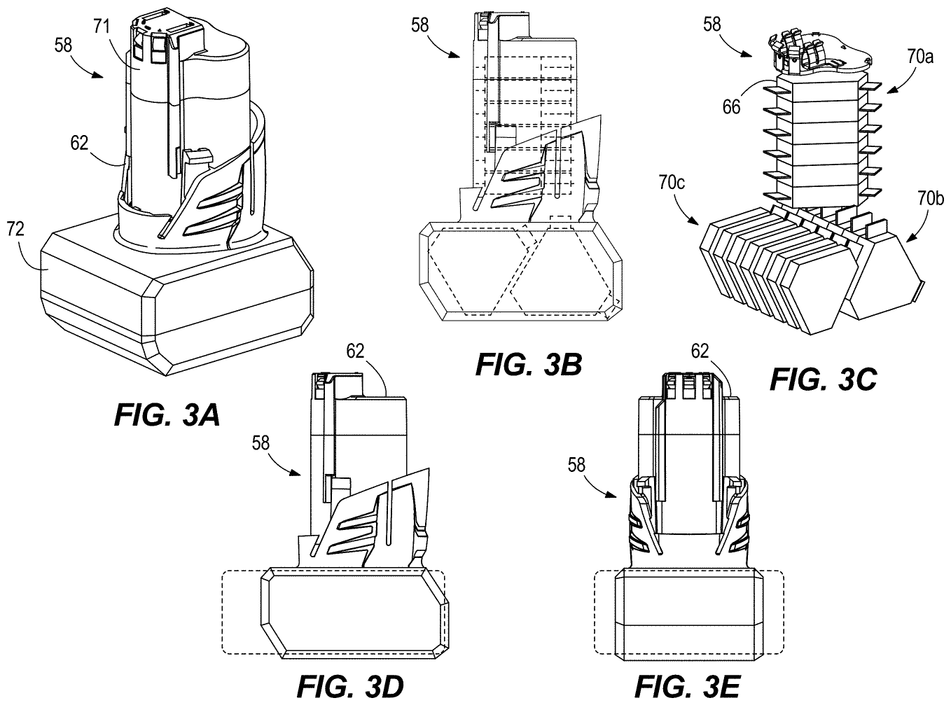

With reference to FIGS. 3A-3E, a battery pack 58 may be provided with an outer housing 62. In one embodiment, the battery pack 58 is configured to have a capacity of between 1.0 A-h and 10.0 A-h, and more specifically, between 5.0 and 7.0 A-h, and more specifically, 6.0 A-h. The battery pack 58 may be configured to house battery cells 66 within the outer housing 62. The battery cells 66 may be provided in three stacks 70a, 70b, 70c. Each stack may have a plurality of flattened stack faces that extend from one end of the stack 70a, 70b, 70c to the other end of the stack 70a, 70b, 70c. In some embodiments, six battery cells 66 are provided in each stack 70a, 70b, 70c. In other embodiments, between two and sixteen battery cells 66 are provided in each stack 70a, 70b, 70c. In some embodiments, different stacks 70a, 70b, 70c contain different numbers of battery cells 66, and in some embodiments, each stack 70a, 70b, 70c contains the same number of battery cells 66. The battery cells 66 may be connected such that the three stacks 70a, 70b, 70c are in series and such that the battery cells 66 within each stack 70a, 70b, 70c are connected in parallel. Six battery cells 66 may be provided in each stack 70a, 70b, 70c. The outer housing 62 of the battery pack 58 may be provided with a male protrusion 71 and a foot portion 72. The male protrusion 71 and the foot portion 72 may be hollow such that the internals (e.g., battery cells) of the battery pack 58 may be provided within either or both of the male protrusion 71 and the foot portion 72.

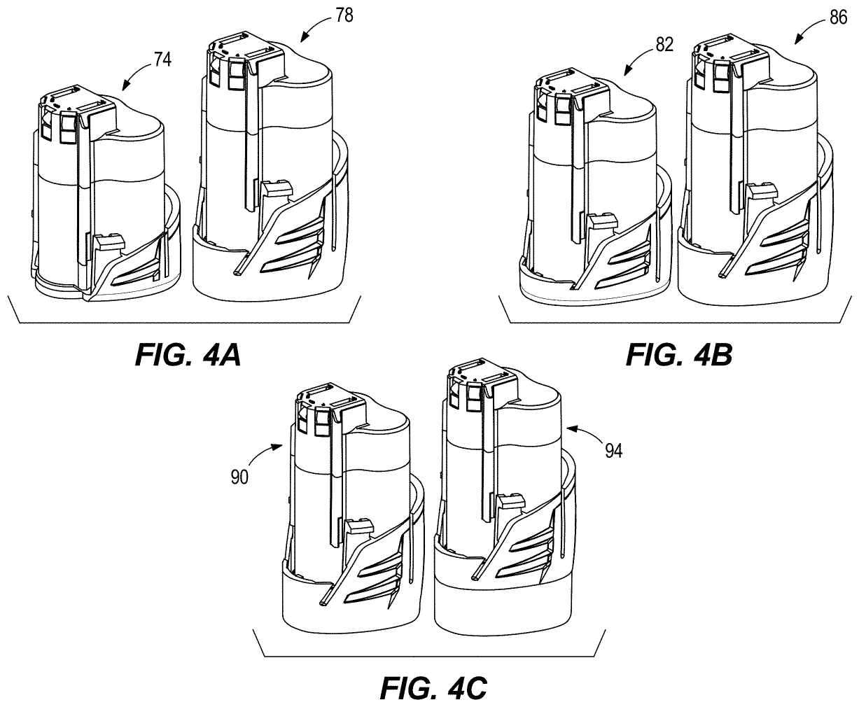

With reference to FIG. 4A, a battery pack 74 may be a different length from a battery pack 78. The battery pack 74 may be a Micro CP battery pack and may have a capacity of between 1.0 and 2.0 A-h, and more specifically, the battery pack 74 may have a capacity of 1.76 A-h. The battery pack 78 may by an MP M12 CP battery pack and may have a capacity of between 1.0 and 2.0 A-h, and more specifically, the battery pack 78 may have a capacity of 1.5 A-h.

With reference to FIG. 4B, a battery pack 82 may be a different length from a battery pack 86. The battery pack 82 may be a Mini CP battery pack and may have a capacity of between 1.0 and 3.0 A-h, and more specifically, the battery pack 82 may have a capacity of 2.0 A-h. The battery pack 86 may by an MP M12 CP battery pack and may have a capacity of between 1.0 and 3.0 A-h, and more specifically, the battery pack 86 may have a capacity of 2.0 A-h.

With reference to FIG. 4C, a battery pack 90 may be a different length from a battery pack 94, and the battery packs 90, 94 may include battery cells of different lengths, diameters, and/or capacities (see FIG. 12). The battery pack 90 may be an M12 MP battery pack and may have a capacity of between 1.0 and 5.0 A-h, and more specifically, the battery pack 90 may have a capacity of 3.0 A-h. The battery pack 94 may be a 3.0 A-h CP battery pack and may have a capacity of between 1.0 and 5.0 A-h, and more specifically, the battery pack 94 may have a capacity of 3.0 A-h.

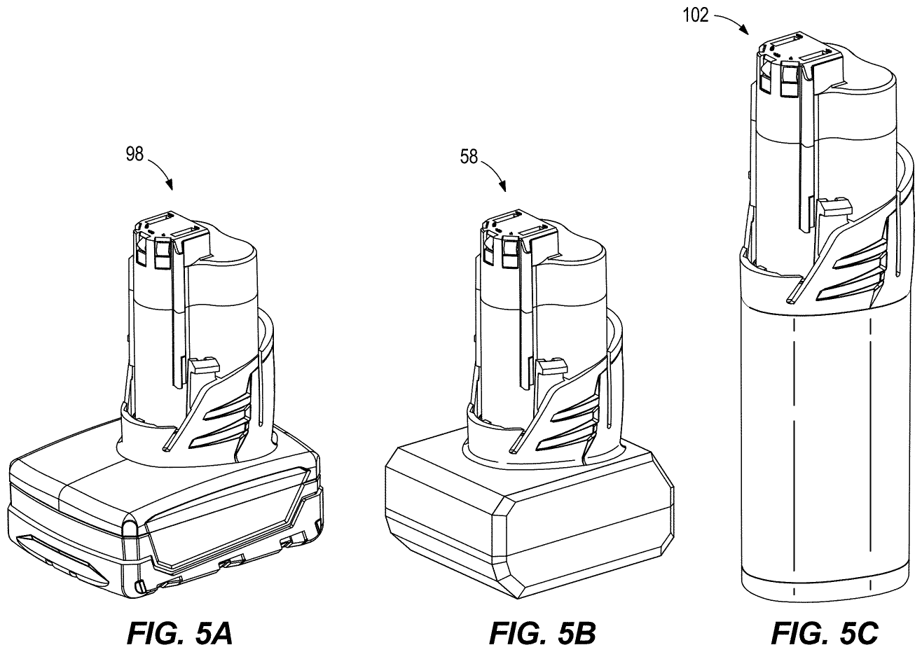

With reference to FIGS. 5A-5C and FIGS. 6A-6E, different types of battery packs 98, 58, 102 may be provided. Each of the battery packs 98, 58, 102 may be configured to interface with the same or different power tools. Each battery pack 98, 58, 102 may have a different shape (i.e., “form factor”) and may each include a battery connection interface that is compatible with a common receptacle. Some examples of power tools that may be powered by battery packs such as the battery packs 98, 58, 102 include, but are not limited to, press tools 103, drills 104, 105, circular saws 107, and rover lights 108, which are shown in FIGS. 6A-6E. The drills 104, 105 may be slotted drive shaft (“SDS”) drills and may be ⅝″, ½″, or another size.

With reference to FIG. 5C, the battery pack 102 may contain three sets of battery cells (not shown), each set of battery cells containing four battery cells. Each of the four battery cells in each set may be connected in parallel, and the three sets of battery cells may be connected in series.

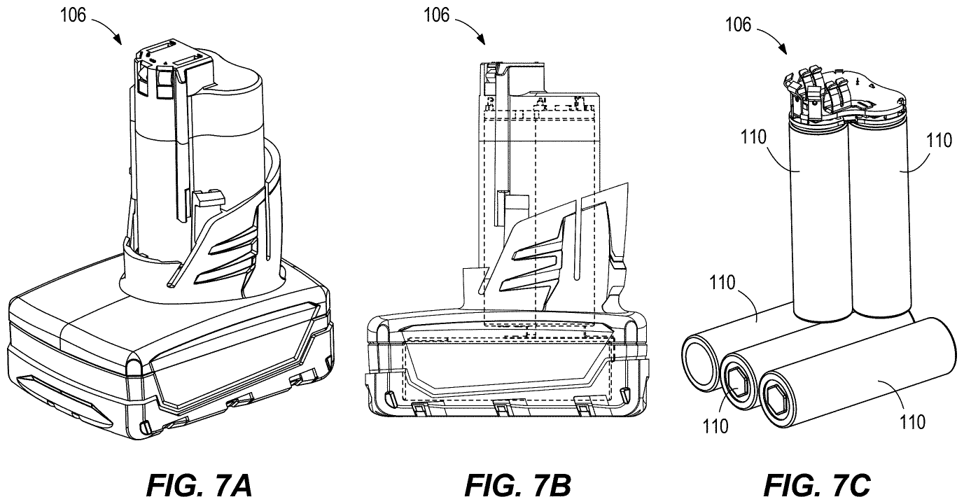

With reference to FIGS. 7A-7C, a battery pack 106 includes cylindrical battery cells 110 that provide power to the battery pack. The battery pack 106 may contain three sets of cylindrical battery cells 110, each set of cylindrical battery cells 110 containing two cylindrical battery cells 110. Each of the two cylindrical battery cells 110 in each set may be connected in parallel, and the three sets of cylindrical battery cells 110 may be connected in series. In some embodiments, one or more of the battery cells 110 in the battery pack 106 may be longer or shorter than other battery cells 110 in the battery pack 106. In other words, battery packs, such as the battery pack 106, may include battery cells of different shapes, sizes (including length, diameter, height, width, etc.), and/or capacities. In some embodiments, some battery cells 110 within the battery pack 106 may be pouch cells, and some cells may be cylindrical cells.

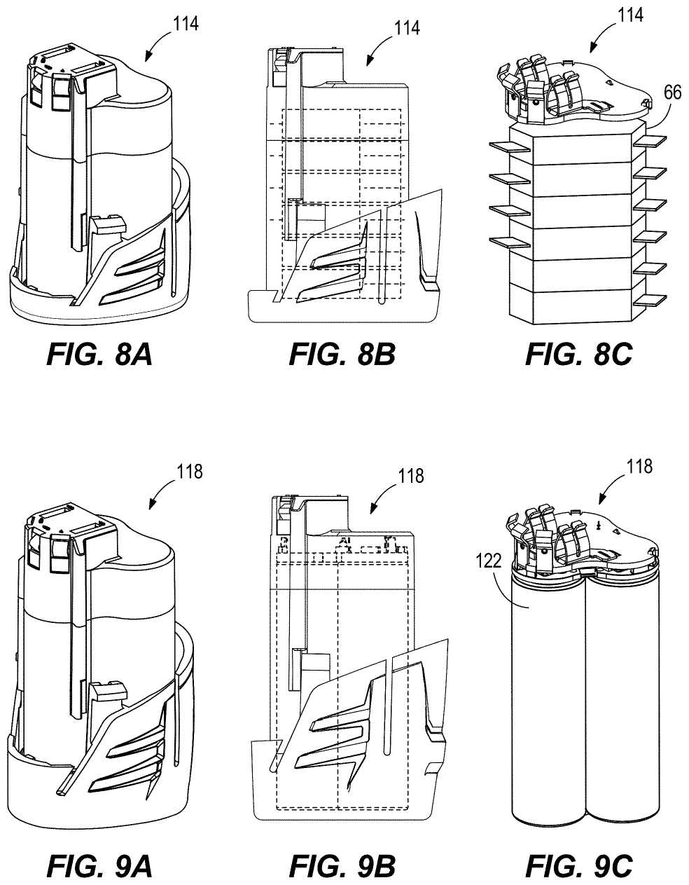

With reference to FIGS. 8A-8C, a battery pack 114 houses battery cells 66 that provide power to the battery pack 114. The battery pack 114 may contain three sets of battery cells 66, each set of battery cells 66 containing two battery cells 66. Each of the two battery cells 66 in each set may be connected in parallel, and the three sets of battery cells 66 may be connected in series.

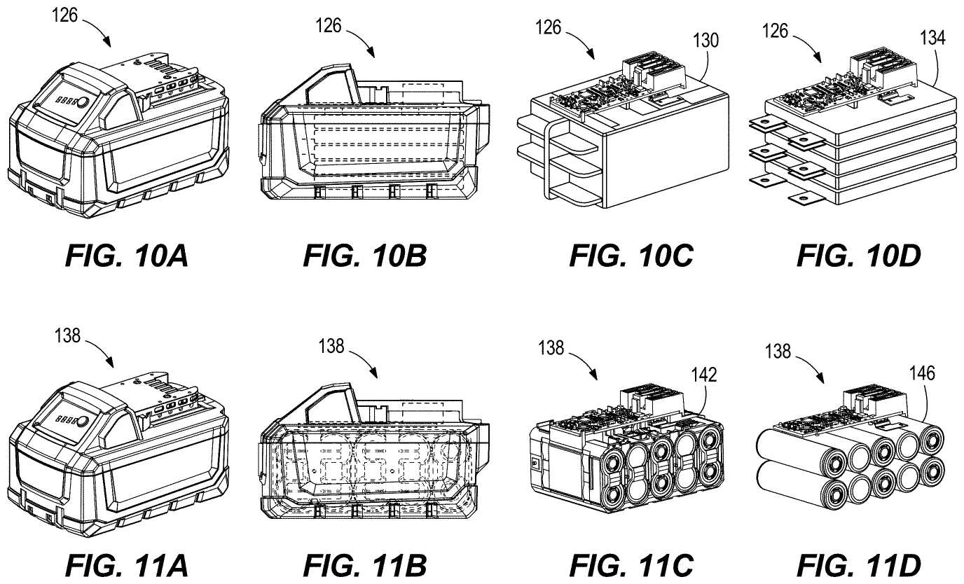

With reference to FIGS. 9A-9C, a battery pack 118 houses battery cells 122 that provide power to the battery pack 118. With returning reference to FIGS. 8A-8C, the battery cells 66 may form a triangle shape, a trilobal shape, or a triangle shape with flattened tips. The battery cells 66 may be stacked so as to occupy approximately the same space as three of the cylindrical battery cells 122. The battery cells 66 may be pouch cells and may make more efficient use of space within the battery pack 114 than the cylindrical battery cells 122 do within the battery pack 118 because the pouch cell battery cells 66 may be able to closely approach the outer housing of the battery pack and because little wasted space is left within the outer housing of the battery pack. The battery cells 122 may be connected in series.

With reference to FIGS. 10A-10D, a battery pack 126 includes an inner housing 130. Battery cells 134 are housed within the inner housing 130. The battery cells 134 may be connected in series.

With reference to FIGS. 11A-11D, a battery pack 138 includes an inner housing 142. Cylindrical battery cells 146 are housed within the inner housing 142. The battery pack 138 may contain five sets of cylindrical battery cells 146, each set of cylindrical battery cells 146 containing two cylindrical battery cells 146. Each of the two cylindrical battery cells 146 in each set may be connected in parallel, and the five sets of cylindrical battery cells 146 may be connected in series. The cylindrical battery cells 146 may be constructed to have different dimensions (e.g. length, width/diameter, and height etc.) and/or capacities (see FIG. 12).

With reference to FIG. 12, a cylindrical battery cell 150 is longer than a cylindrical battery cell 154. The cylindrical battery cell 150 is an 18650 cell, and the cylindrical battery cell 154 is an 18435 cell and is 43.5 mm long, varying within 2%. The cylindrical battery cell 150 may be approximately 65 mm long or may be a different length. Battery packs may be manufactured that are configured to house the cylindrical battery cell 150 or to house the cylindrical battery cell 154. Battery packs may also be manufactured that are configured to house both the cylindrical battery cell 150 and the cylindrical battery cell 154 simultaneously. In some embodiments, a battery pack may house three or more battery cells of different sizes, shapes, and/or capacities. A cylindrical battery cell similar to the cylindrical battery cells 150, 154 may have a length that is greater than, equal to, or less than 60 mm or that is greater than, equal to, or less than 80 mm. A cylindrical battery cell similar to the cylindrical battery cells 150, 154 may have a diameter that is greater than, equal to, or less than 15 mm or that is greater than, equal to, or less than 55 mm. A cylindrical battery cell similar to the cylindrical battery cells 150, 154 may have an energy density of greater than, equal to, or less than 500 Wh/L, an energy density of greater than, equal to, or less than 585 Wh/L, or an energy density that is greater than, equal to, or less than 595 Wh/L.

With reference to FIGS. 13A and 13C, a battery pack 158 is shown in FIG. 13A. The battery pack 158 houses the cylindrical battery cells 154, as shown in FIG. 13C. The battery pack 158 may have a capacity of 2.0 A-h and may be a size of the Micro CP 1.76 A-h battery pack 74 as shown in FIG. 4A. The cylindrical battery cells 154 may be connected in series.

With reference to FIGS. 13B and 13D, a battery pack 162 is shown in FIG. 13B. The battery pack 162 houses the cylindrical battery cells 150, as shown in FIG. 13D. The battery pack 162 may have a capacity of 2.0 A-h. The cylindrical battery cells 150 may be connected in series.

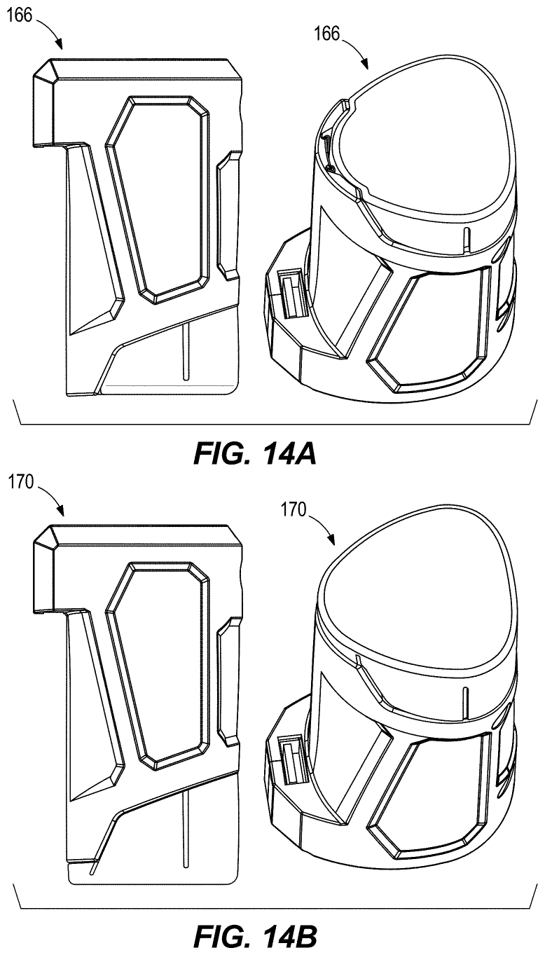

With reference to FIGS. 14A and 14B, a battery pack 166 and a battery pack 170 may be different lengths. The battery pack 166 may be a Micro M12 battery pack. The battery cells contained within the battery pack 166 may be flush with a tool handle when the battery pack 166 is installed within a tool handle. The battery pack 170 may be a Mini M12 battery pack or may be a larger M12 battery pack in which the battery cells contained within the battery pack 170 extend past a tool handle when the battery pack 170 is installed within a tool handle.

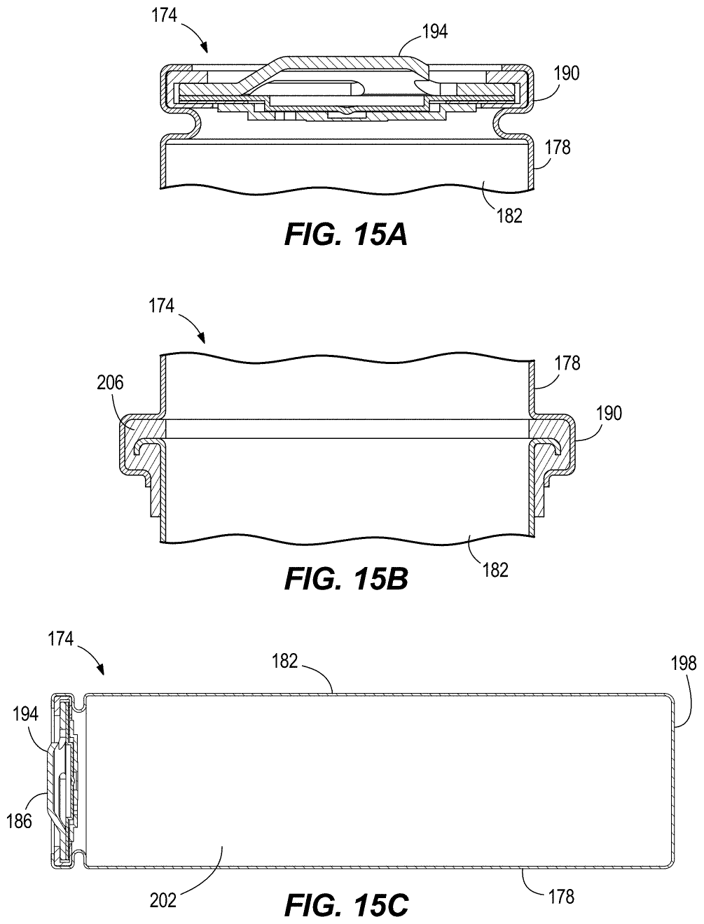

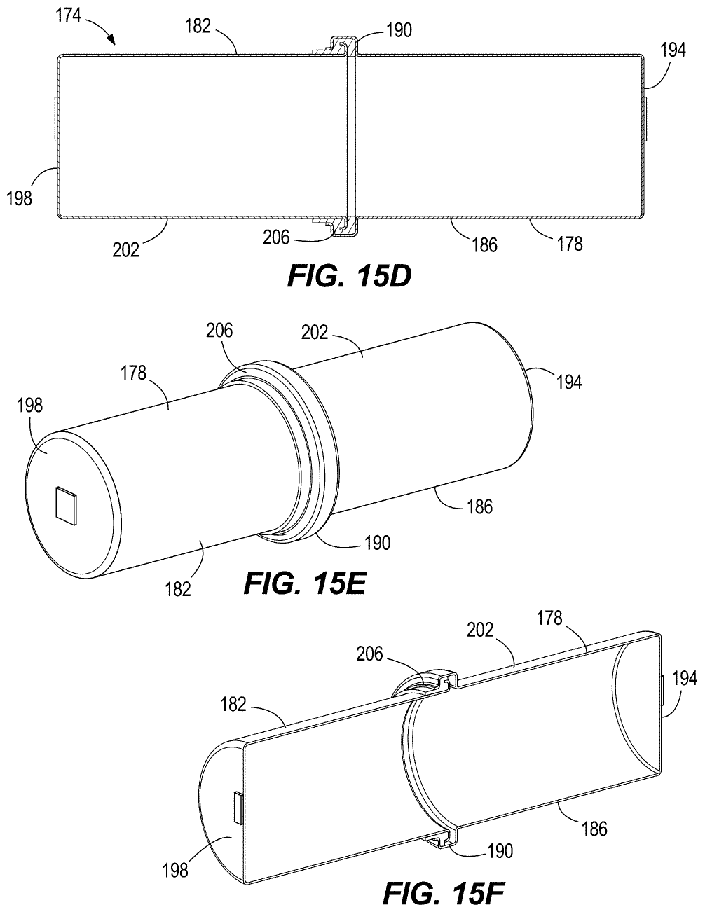

With reference to FIGS. 15A-15F, a battery cell 174 may include a battery cell housing 178 which may also be called a cell can 178. The battery cell housing 178 may include an anode 182 and cathode 186. The battery cell 174 may include a first end 194, a second end 198, and a middle portion 202. The anode 182 may be separated from the cathode 186 by a separator 190 that includes a gasket. The separator 190 may be positioned at a location on the battery cell 174 at which the battery cell housing 178 is crimped. In some embodiments, such as the embodiment of the battery cell 174 shown in FIGS. 15A and 15C, the cathode 186 may be disposed at the first end 194 of the battery cell 174, and the anode 182 may be disposed at the second end 198 of the battery cell 174. In other embodiments, such as the embodiment of the battery cell 174 shown in FIGS. 15B and 15D-15F, the cathode may extend along the length of the battery cell housing 178 from the first end to a central crimp 206. In such an embodiment, a first side of the middle portion 202 is the cathode, and a second side of the middle portion 202 is the anode. The first side may be a first cell can piece, and the second side may be a second cell can piece. The battery cell 174 may be a cylindrical cell.

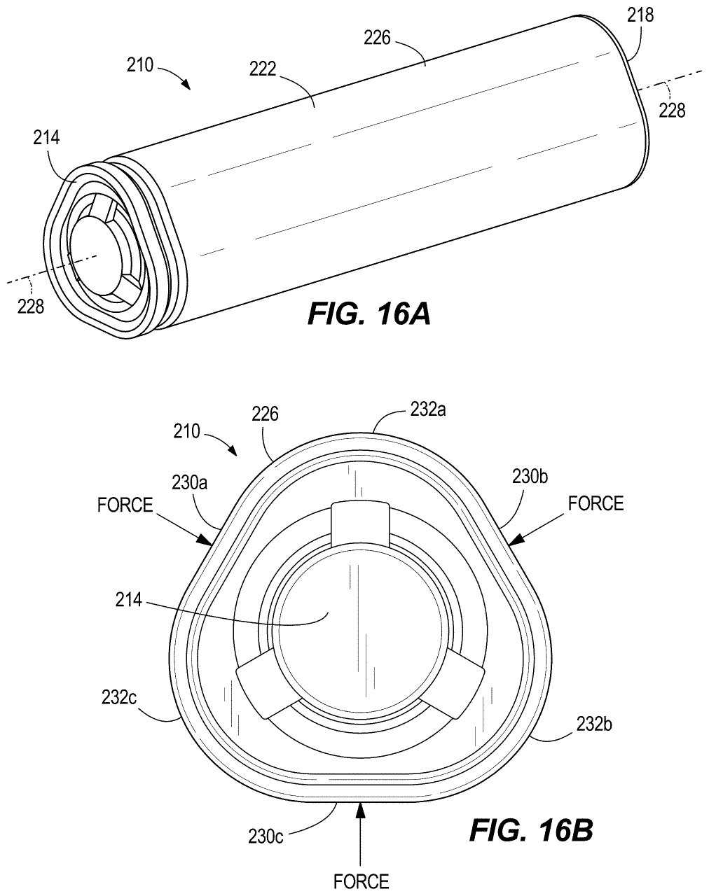

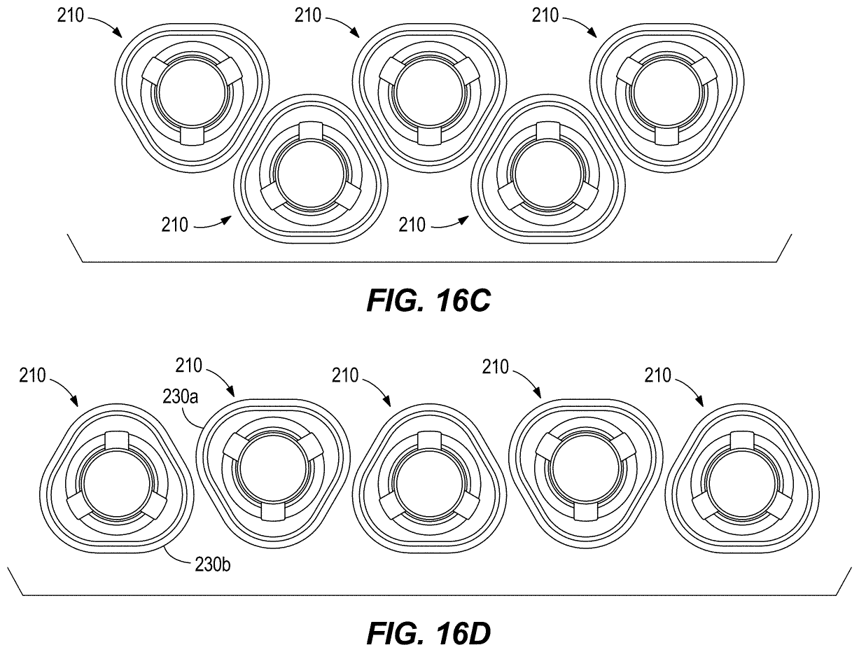

With reference to FIGS. 16A-16D, a battery cell 210 is a smashed battery cell 210. The smashed battery cell 210 includes a first end 214 having electrical connections, a second end 218, and a body portion 222. The body portion 222 includes a cell side surface 226 that extends between the first end 214 and the second end 218. The battery cell 210 has a longitudinal axis 228 that extends between the first end 214 and the second end 218. The cell side surface 226 is not a perfect cylinder. The cell side surface 226 includes a first face 230a, a second face 230b, and a third face 230c. The cell side surface also includes a first corner 232a, a second corner 232b, and a third corner 232c. From a view from an end 214, 218 such as is shown in FIG. 16B, the faces 230a, 230b, 230c appear flat, flattened, or smashed. In some embodiments, the faces 230a, 230b, 230c are flat, but in other embodiments, the faces 230a, 230b, 230c are simply smashed such that the faces 230a, 230b, 230c are out of round and that the body portion 222 of the battery cell 210 is trilobal or triangular. In other words, a two-dimensional projection of the battery cell 210 on a plane perpendicular to the longitudinal axis 228 is noncircular. In some embodiments, a two-dimensional projection of the battery cell 210 on a plane perpendicular (e.g., orthogonal) to the longitudinal axis 228 is nonrectangular.

With further reference to FIG. 16B, the flat, flattened, or smashed geometry of the battery cell 210 may be formed by applying force along the length of the body portion 222 of the battery cell 210. For example, force may be applied as shown in FIG. 16B in three different directions towards the longitudinal axis 228. A method of forming the battery pack 210 includes simultaneously applying force to the battery cell 210 from at least three different directions that are uniformly spaced apart from each other and molding the battery cell 210 into a desired uniformly prismatic shape.

With further reference to FIGS. 16C and 16D, battery cells 210 may be arranged in a space-saving manner. In FIG. 16C, the shortest distance between the longitudinal axes of two adjacent battery cells 210 passes through a face of each of the two adjacent battery cells 210. In FIG. 16D, the battery cells 210 are arranged in a row. In such a configuration, one of the corners 232a, 232b, 232c of a battery cell 210 overlaps one of the corners 232a, 232b, 232c of an adjacent battery cell 210.

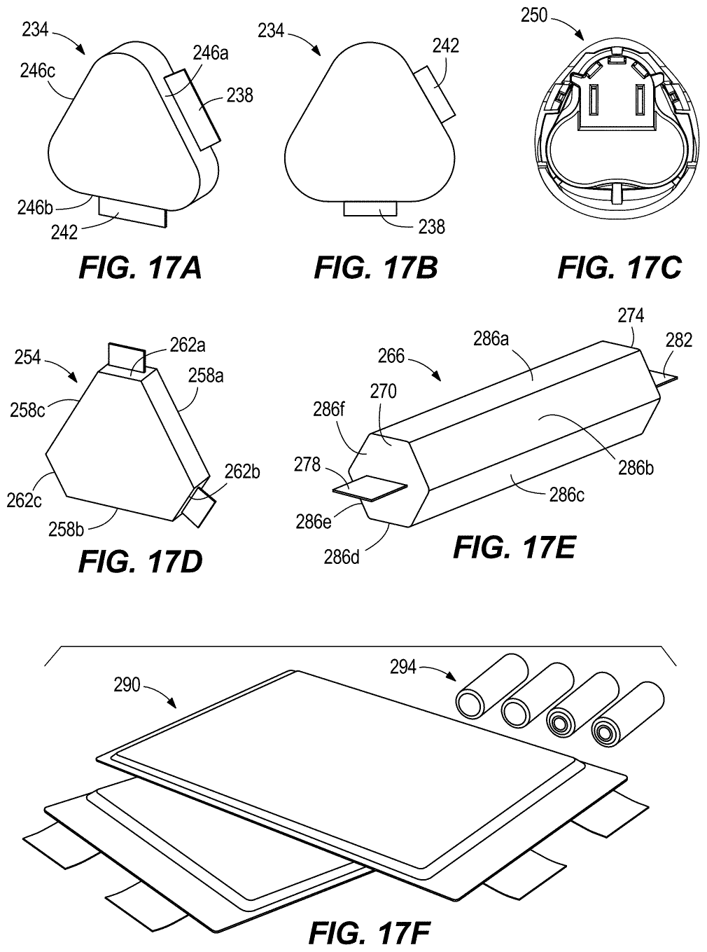

With reference to FIGS. 17A-17C, a battery cell 234 includes a first tab 238 and a second tab 242. The battery cell 234 may be a pouch cell and may include, analogously to the battery cell 210 of FIGS. 16A-16D, faces 246a, 246b, 246c. The faces 246a, 246b, 246c may be flat, flattened, or smashed. Each of the tabs is disposed on a face 246a, 246b, 246c. One of the faces 246a, 246b, 246c may not have a tab. The battery cell 234 is trilobal and configured to fit within a battery pack 250 as shown in FIG. 17C.

With reference to FIG. 17D, a battery cell 254 is analogous to the battery cell 234, but includes both major faces 258a, 258b, 258c and minor faces 262a, 262b, 262c. In the illustrated embodiment, tabs are disposed on the minor faces. The major faces 258a, 258b, 258c and minor faces 262a, 262b, 262c may be arranged in an alternating manner forming a triangular shape.

With reference to FIG. 17E, a battery cell 266 has a hexagonal cross section. The battery cell 266 is provided with a first end 270, a second end 274, a tab 278 at the first end 270, and a tab 282 at the second end 274. The battery cell 266 is also provided with six faces 286a, 286b, 286c, 286d, 286e, 286f. Battery cells 266 may be arranged in a space-saving fashion in the manner of FIG. 16C. In other embodiments, the battery cell 266 may have three faces, four faces, five faces, seven faces, eight faces or another number of faces.

With reference to FIG. 17F, a battery cell 290 may be of a flat, rectangular type. Cylindrical battery cells 294 may also be provided.

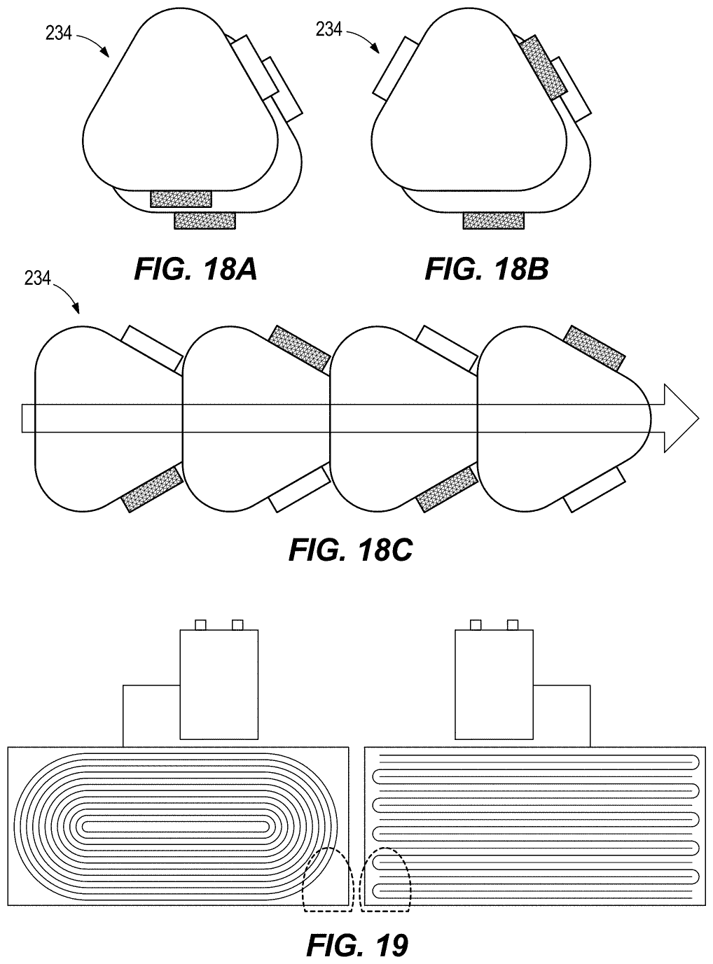

With reference to FIGS. 18A-18C, battery cells 234 may be connected in various ways. As shown in FIGS. 18A and 18B, the battery cells 234 may be stacked. As shown in FIG. 18A, the battery cells 234 may be connected in parallel. As a result, in FIG. 18A, the orientation of each battery cell 234 in a stack may be the same relative to an adjacent battery cell 234 in order to facilitate the connection of the tabs of each battery cell 234 to another battery cell 234 in parallel. As shown in FIG. 18B, battery cells 234 may be connected in series. As a result, in FIG. 18B, the orientation of each battery cell 234 in a stack may be different relative to an adjacent battery cell 234 in order to facilitate the connection of the tabs of each battery cell 234 to another battery cell 234 in series. The battery cells 234 may be connected in these ways inside a battery pack and configured to power a power tool. As shown in FIG. 18C, the battery cells 234 may be arranged in a row and connected in series. Although not shown, the battery cells 234 may also be arranged in a row and connected in parallel. Further, as previously discussed, one face of the battery cells 234 may not have a tab, which facilitates the arrangement of the battery cells 234 in a row as shown in FIG. 18C. Because the battery cells 234 have a tab on two faces but have one face without a tab, the battery cells 234 can be rotated or flipped to make these various designs such as rows and stacks.

With reference to FIG. 19, a battery cell may be produced by either winding technology or by stacking technology.

Battery cells can be mass produced using multiple methods. For example, pre-cut electrodes and cell components can be stacked together to form a cell. Another method is to stack a square or rectangle shape cell and then cut the cell stack to shape. Another method is to make a continuous electrode/separator and then “Z fold” the electrode to stack.

With further reference to FIGS. 3A-3E, the stacks 70a, 70b, 70c may be arranged in a pattern within the outer housing 62. Each stack 70a, 70b, 70c has a longitudinal axis. The longitudinal axis of stack 70a is perpendicular the longitudinal axis of both stack 70b and stack 70c. Further, the stack 70a is positioned at least partially over both of the stacks 70b, 70c. In other words, the longitudinal axes of two of the stacks 70b, 70c are parallel and are both perpendicular to the longitudinal axis of the stack 70a.

The battery packs disclosed herein may be configured to include the battery cells disclosed herein. The battery cells may be connected in series or in parallel. Cells can be rotated to easily create a series connection. Cells can be flipped to create a parallel connection. Additionally, one side of the connected cell stack can be left with no tabs on it thus leaving space for wiring or other pack internal features.

Certain battery packs may have a height of between 50 and 100 mm, and more specifically, between 64.58 mm and 85 mm. More specifically, certain battery packs may have a height of 85 mm, 64.58 mm, and 72.5 mm. Other battery packs may have a cell height of 95.5 mm.

Certain battery packs may have a cell weight of between 50 g and 150 g, and more specifically, between 66.3 g and 128 g. More specifically, certain battery packs may have a cell weight of 126.5 g, 66.3 g, 128 g, and 75.6 g. Other battery packs may have a cell weight of 138 g or 113.2 g.

Certain battery packs may have an AC-IR (A/C internal resistance) of between 5 mOhm and 50 mOhm, and more specifically, between 10.5 mOhm and 38.91 mOhm. Other battery packs may have an AC-IR of 34.8 mOhm or 10.5 mOhm.

The battery pack 98 may have a size of 66.6 mm wide by 88.3 mm long by 111 mm tall, a cell weight of 276 g, and an AC-IR of 17.4 mOhm. Those characteristics may vary by 25%.

The battery pack 58 may have a size of 56.95 mm by 73.5 mm by 113.3 mm, a cell weight of 226.5 g, and an AC-IR of 3.5 mOhm. Those characteristics may vary by 25%.

The battery pack 102 may have a size of 47.8 mm by 51.4 mm by 169.25 mm, a cell weight of 226.4 g, and an AC-IR of 5.25 mOhm. Those characteristics may vary by 25%.

Certain battery cells disclosed herein may have a cell thickness of 14 mm.

As shown in the tables below, various battery packs may have various pack heights, usable cell heights, and single cell heights (measured in millimeters). Further, the various battery packs may have various associated single cell capacity, measured in Amp-hours (“A-h” or “Ah”). The battery packs may be configured with battery cells in series, in parallel, or in a combination. The battery packs themselves may have a capacity measured in Amp-hours. Each battery pack may have a volume per cell (measured in cubic millimeters), and each battery pack may have a weight per cell measured in grams. Each battery pack may have a total cell weight measured in grams.

TABLE 1-1

| | Pack | Usable Cell | Single Cell |
|---|---|---|---|
| | Height | Height | height |
| M12 Pack | mm | mm | mm |
| 18650 M12 CP | 85 | 65 | 65.0 |
| Micro | 64.58 | 43.58 | 13.5 |
| Mini | 70.08 | 49.08 | 7.3 |
| Mini 2 Ah | 72.5 | 51.5 | 7.7 |
| M12 CP | 85 | 64 | 9.8 |
| 3 Ah | 95.5 | 74.5 | 11.5 |
| M12 XC Height | 111.37 | 90.37 | 9.2 |
| 4 Ah | 120.75 | 99.75 | 10.3 |
| 5 Ah | 144 | 123 | 12.8 |
| 6 Ah | 169.25 | 148.25 | 11.5 |
| 18650 M12 XC 6 Ah | 111.37 | | |
| 5.27 Ah Pouch | 113.3 | Same as Micro | 13.5 |
| | | 1.76 Ah Cell | |
| 6 Ah Pouch | 113.3 | Same as Mini 2.0 Ah | 7.7 |
| | | Cell | |

TABLE 1-2

| | Single Cell | | Pack |
|---|---|---|---|
| | Capacity | | Capacity |
| M12 Pack | Ah | Configuration | Ah |
| 18650 M12 CP | 3.000 | 3S1P | 3.00 |
| Micro | 1.758 | 3S1P | 1.76 |
| Mini | 0.950 | 3S2P | 1.90 |
| Mini 2 Ah | 1.002 | 3S2P | 2.00 |
| M12 CP | 1.273 | 3S2P | 2.55 |
| 3 Ah | 1.500 | 3S2P | 3.00 |
| M12 XC Height | 1.197 | 3S3P | 3.59 |
| 4 Ah | 1.333 | 3S3P | 4.00 |
| 5 Ah | 1.668 | 3S3P | 5.01 |
| 6 Ah | 1.500 | 3S4P | 6.00 |
| 18650 M12 XC 6 Ah | 3 | 3S2P | 6 |
| 5.27 Ah Pouch | 1.758 | 3S3P | 5.27 |
| 6 Ah Pouch | 1.002 | 3S6P | 6.01 |

TABLE 1-3

| | Vol/Cell | Weight/Cell | Total Cell Weight |
|---|---|---|---|
| M12 Pack | mm³ | g | g |
| 18650 M12 CP | | 46.0 | 137.97 |
| Micro | 9896.0 | 22.1 | 66.3 |
| Mini | 5344.3 | 11.9 | 71.6 |
| Mini 2 Ah | 5639.3 | 12.6 | 75.6 |
| M12 CP | 7163.5 | 16.0 | 96.0 |
| 3 Ah | 8443.8 | 18.9 | 113.2 |
| M12 XC Height | 6736.0 | 15.0 | 135.4 |
| 4 Ah | 7498.8 | 16.8 | 150.8 |
| 5 Ah | 9388.7 | 21.0 | 188.8 |
| 6 Ah | 8443.8 | 18.9 | 226.4 |
| 18650 M12 XC 6 Ah | | 46 | 276 |
| 5.27 Ah Pouch | | 22.1 | 198.6 |
| 6 Ah Pouch | | 12.6 | 226.5 |

TABLE 2-1

| | Pack | Usable Cell | Single Cell |
|---|---|---|---|
| | Height | Height | Height |
| M12 Pack | mm | mm | mm |
| 18650 M12 CP | 85 | 65 | 65 |
| Micro 1.76 Ah Size | 64.58 | 43.58 | 43.58 |
| Mini 2.0 Ah Size | 72.5 | 51.5 | 51.5 |
| 4 Ah | 107.7 | 86.7 | 86.7 |
| 5 Ah | 129.4 | 108.4 | 108.4 |
| 6 Ah | 151 | 130 | 130 |

TABLE 2-2

| | Single Cell | | Pack |
|---|---|---|---|
| | Capacity | | Capacity |
| M12 Pack | Ah | Configuration | Ah |
| 18650 M12 CP | 3.000 | 3S1P | 3 |
| Micro 1.76 Ah Size | 2.011 | 3S1P | 2.011 |
| Mini 2.0 Ah Size | 2.377 | 3S1P | 2.377 |
| 4 Ah | 4.002 | 3S1P | 4.002 |
| 5 Ah | 5.003 | 3S1P | 5.003 |
| 6 Ah | 6.000 | 3S1P | 6.000 |

TABLE 2-3

| | Vol/Cell | Weight/Cell | Total Cell Weight |
|---|---|---|---|
| M12 Pack | mm³ | g | g |
| 18650 M12 CP | 16540.5 | 45.99 | 137.97 |
| Micro 1.76 Ah Size | 11089.8 | 30.83 | 92.50 |
| Mini 2.0 Ah Size | 13105.2 | 36.44 | 109.31 |
| 4 Ah | 22062.5 | 61.34 | 184.03 |
| 5 Ah | 27584.4 | 76.70 | 230.09 |
| 6 Ah | 33081.0 | 91.98 | 275.94 |

As shown in the table below, each cell may have a characteristic A/C internal resistance, and each pack may have its own characteristic A/C internal resistance measured in milliOhms.

TABLE 3
Est. Pack ACIR

| Cell Only | | | 3S1P | 3S2P | 3S3P | 3S4P | 3S5P | 3S6P | 3S6P |
|---|---|---|---|---|---|---|---|---|---|
| 15MMM | 12.17 | mOhm | 36.51 | 18.26 | | | | | |
| ACIR | | | | | | | | | |
| 20R | 12.97 | mOhm | 38.91 | 19.46 | | | | | |
| ACIR | | | | | | | | | |
| VX25 | 6.35 | mOhm | 19.05 | 9.53 | | | | | |
| ACIR | | | | | | | | | |
| 25S2 | 10.59 | mOhm | 31.77 | 15.855 | | | | | |
| ACIR | | | (38.7) | (22.3) | | | | | |
| 30Q | 11.6 | mOhm | 34.8 | 17.4 | | | | | |
| ACIR | | | | (25) | | | | | |
| Pouch | 7 | mOhm | 21 | 10.5 | 7 | 5.52 | 4.2 | 3.5 | 3.5 |
| ACIR | | | | | | | | | |
| (4-7) | | | | | | | | | |
| 30T-TT | 6.93 | mOhm | | | 6.93 | | | | |
| ACIR | | | | | | | | | |

With returning reference to FIG. 12, the cylindrical battery cells 150, 154 may be custom-made to have different dimensions as desired. For example, the cylindrical battery cells 150, 154 may have diameters of 24 mm, 27 mm, or 28 mm and may have lengths of 80 mm, 70 mm, or 75 mm. More particularly, an embodiment of a cylindrical battery cell 150, 154 may be constructed to have a diameter of 24 mm, a length of 80 mm, a cell volume of 36,191 mm³, an example cell capacity of 5.97 Ah, an example cell ACIR of 2.91 mohm, and an example cell DCIR of 7.1 mohm. An embodiment of a cylindrical battery cell 150, 154 may be constructed to have a diameter of 27 mm, a length of 70 mm, a cell volume of 40,079 mm³, an example cell capacity of 6.61 Ah, an example cell ACIR of 2.71 mohm, and an example cell DCIR of 6.6 mohm. An embodiment of a cylindrical battery cell 150, 154 may be constructed to have a diameter of 28 mm, a length of 75 mm, a cell volume 46,181 mm³, a cell capacity of 7.62 Ah, a cell ACIR of 2.35 mohm, and a cell DCIR of 5.71 mohm. Battery cells 150, 154 of different sizes, shapes, diameters, lengths, and/or capacities may be provided within a single battery pack. The example dimensions described above are shown in the table below:

TABLE 4

| Cell | Cell | Cell | Cell | | |
|---|---|---|---|---|---|
| Diameter | Length | Volume | Capacity | Cell ACIR | Cell DCIR |
| (mm) | (mm) | (mm\hat{ }3) | (Ah) | (mohm) | (mohm) |
| 24 | 80 | 36191 | 5.97 | 2.91 | 7.1 |
| 27 | 70 | 40079 | 6.61 | 2.71 | 6.6 |
| 28 | 75 | 46181 | 7.62 | 2.35 | 5.71 |

With continued reference to FIG. 12, other embodiments of cylindrical battery cells 150, 154 may be constructed such that diameters range from 25-28 mm, such that cell lengths range from 70-75 mm, such that cell capacities range from 4.8-7.6 Ah. Embodiments of the cylindrical battery cells 150, 154 may be installed within a battery pack, such as one of the battery packs described herein, such that the battery pack capacity ranges from 14.4-23 Ah. Cylindrical battery cells 150, 154 may be custom-constructed in order to maximize a battery pack capacity for a given battery pack size (i.e., to maximize energy density).

With continued reference to FIG. 12, one particular example embodiment of the cylindrical battery cells 150, 154 is a 21700 VX40 cell having a diameter of 21 mm, a longitudinal dimension (which may be called a length) of 70 mm, a volume of 24,245 mm³, a weight of 70 g, and a cell capacity of 4 Ah. In one embodiment, such cylindrical battery cells 150, 154 or different cells may be placed within a battery pack housing having an example length of 186.125 mm, an example width of 86 mm, an example height of 143.6384 mm, and an example volume of 1,799,466 mm³ (in other words, 1,799 cm³ and 1.8 L). The dimensions listed above are presented in the tables below:

TABLE 5-1
VX40 - Cell Capacity Estimation (Ah)

| | Diameter | | | | |
|---|---|---|---|---|---|
| | (“Dia.”) | | Volume | | Capacity |
| Cell | (mm) | Height (mm) | (mm3) | Weight (g) | (Ah) |
| 21700 | 21 | 70 | 24245 | 70 | 4 |

TABLE 5-2
5S4P - Concept 3 Housing

| Length | Width | Height | Volume | Volume | Volume |
|---|---|---|---|---|---|
| (mm) | (mm) | (mm) | (mm\hat{ }3) | (cm\hat{ }3) | (L) |
| 186.125 | 86 | 143.6384 | 1799466 | 1799 | 1.8 |

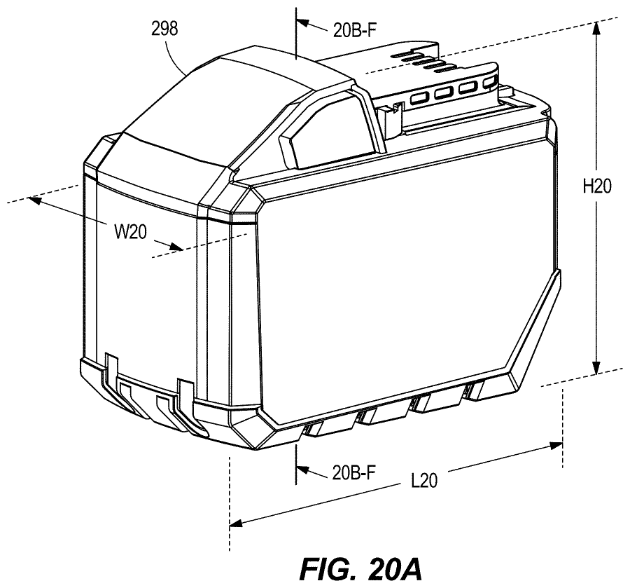

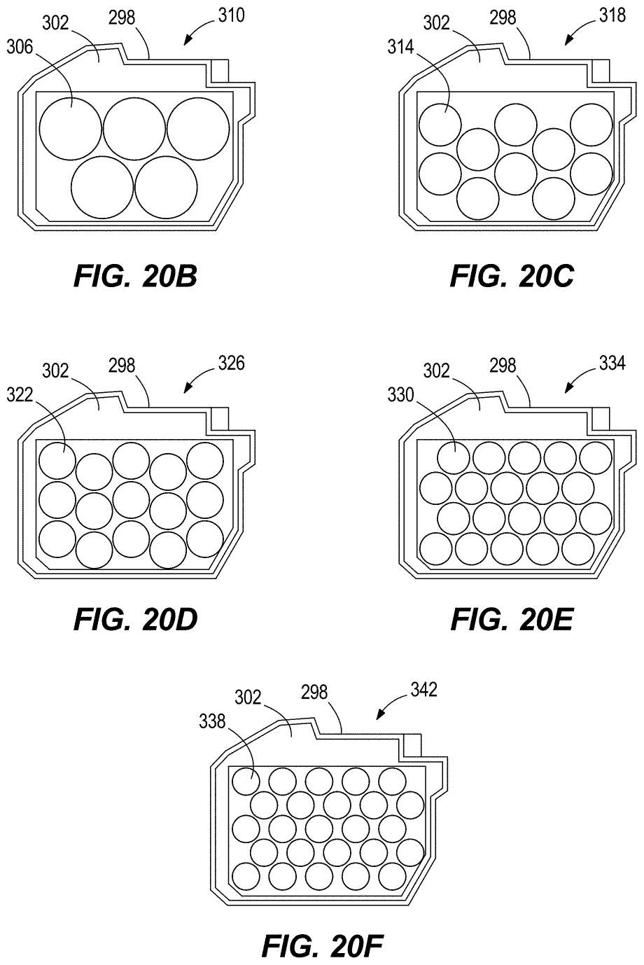

With reference to FIG. 20A, a battery pack housing 298 may have a length L20 of 151.242 mm, a width W20 of 86 mm, and a height H₂O of 119.1798 mm. The battery pack housing 298 may have an internal volume 302 of 1,119,909 mm³ (i.e., 1200 cm³ and 1.2 L) (FIGS. 20B-20F). These dimensions of the battery pack housing 298 are listed in the following table:

TABLE 6

| Length | Width | Height | Volume | Volume | Volume |
|---|---|---|---|---|---|
| (mm) | (mm) | (mm) | (mm\hat{ }3) | (cm\hat{ }3) | (L) |
| 151.1242 | 86 | 119.1798 | 1199909 | 1200 | 1.2 |

The battery pack housing 298 may have an available volume as shown in the table below:

TABLE 7

| | mm\hat{ }3 | cm\hat{ }3 | L |
|---|---|---|---|
| Available Volume: | 635715 | 635.7 | 0.64 |

With reference to FIG. 20B, the battery pack housing 298 may be provided with a plurality of, and particularly five, cylindrical battery cells 306 therein to form a battery pack 310. The cylindrical battery cells 306 may have a cell diameter of 40 mm, a cell length of 70 mm, a cell volume of 87,965 mm³, a cell capacity of 14.5 Ah, a cell ACIR of 16.0 mohm, and a cell DCIR of 38.9 mohm. The battery pack 310 may have a pack capacity of 14.5 Ah, an energy of 261 Wh, an energy density of 218 Wh/L, and a volumetric packing efficiency of 36.7%. The cell volume is calculated by using the formula for calculating a volume of a cylinder (pi*radius²), and this formula is used for calculating cell volume of cylindrical cells throughout this disclosure. Each cylindrical battery cell 306 within the battery pack 310 may be connected in series. A battery pack, such as the battery pack 310, may be defined by a number of groups (or, in other words, a number of “rows”) of battery cells that are connected in parallel. In the battery pack 310, since each cylindrical battery cell 306 is connected in series, the entire group of five battery cells 306 may be considered to be a single group or “row” of battery cells. In some embodiments, the battery cells 306 may have different sizes, shapes, lengths, and/or capacities.

In some embodiments, if a cell capacity of a first cylindrical battery pack of a first cell volume is known, then a cell capacity of a second cylindrical battery cell of a second cell volume may be calculated by dividing the second cell volume by the first cell volume and multiplying that product by the capacity of the first cylindrical battery cell. This formula may be used for calculating cell capacity of cylindrical battery cells in this disclosure.

In some embodiments, if a cell ACIR of a first cylindrical battery pack of a first cell volume is known, then a cell ACIR of a second cylindrical battery cell of a second cell volume may be calculated by dividing the second cell volume by the first cell volume and multiplying that product by the ACIR of the first cylindrical battery cell. This formula may be used for calculating cell ACIR of cylindrical battery cells throughout this disclosure.

In some embodiments, if a cell DCIR of a first cylindrical battery pack of a first cell volume is known, then a cell DCIR of a second cylindrical battery cell of a second cell volume may be calculated by dividing the second cell volume by the first cell volume and multiplying that product by the DCIR of the first cylindrical battery cell. This formula may be used for calculating cell DCIR of cylindrical battery cells throughout this disclosure.

Pack capacity may be calculated by multiplying a cell capacity of one of the cells within a battery pack by a number of rows of battery cells that are connected in parallel within the battery pack. This formula may be used for calculating a pack capacity throughout this disclosure. In the battery pack 310, for example, since a single cylindrical battery cell 306 has a cell capacity of 14.5 Ah and only a single row of battery cells is connected in parallel, the battery pack 310 has a pack capacity of 14.5 Ah.

Battery pack energy (or, for the purposes of this disclosure, simply “energy”) may be calculated by multiplying the pack capacity (which has units of Ah, or “amp-hours”) with the voltage of the battery pack. In general, in this disclosure, many of the specific examples of battery packs are 18-volt battery packs, but battery packs of different voltages may be provided. More specifically, the battery pack examples provided in this disclosure may include five 3.6-volt battery cells connected in series, yielding a battery pack voltage of 5*3.6-volts=18 volts. Therefore, because the battery pack 310 includes five 3.6 volt battery cells connected in series, and as a result has a battery pack voltage of 18 volts, the energy of the battery pack 310 is 261 Wh.

An energy density of a battery pack may be calculated by dividing battery pack energy (or simply “energy”) by an internal volume of the housing of the battery pack. Because the battery pack housing 298 has an internal volume of 1,199,909 mm³, and because the battery pack 310 has an energy of 261 Wh, the battery pack 310 has an energy density of 218 Wh/L.

A volumetric packing efficiency (or “Vol. Packing Efficiency %”) may be calculated by first calculating a total volume of the battery cells within a battery pack, dividing the total volume of the battery cells within the battery pack by the internal volume of the battery pack, and multiplying by 100 to obtain a percentage. For example, the battery pack 310 includes five battery cells 306, each battery cell 306 having a cell volume of 87,965 mm³. Therefore, the total volume of the battery cells 306 within the battery pack 310 is 439,825 mm³. Because the internal volume of the battery pack housing 298 is 1,199,909 mm³, the volumetric packing efficiency of the battery pack 310 is 36.7%.

With reference to FIG. 20C, the battery pack housing 298 may be provided with a plurality of, and particularly ten, cylindrical battery cells 314 therein to form a battery pack 318. The cylindrical battery cells 314 may have a cell diameter of 28 mm, a cell length of 70 mm, a cell volume of 43,103 mm³, a cell capacity of 7.1 Ah, a cell ACIR of 7.8 mohm, and a cell DCIR of 19.1 mohm. The battery pack 318 may have a pack capacity of 14.2 Ah, an energy of 256 Wh, an energy density of 213 Wh/L, and a volumetric packing efficiency of 35.9%. The battery pack 318 may include two groups (or “rows”) of battery cells 314 that are connected in parallel to each other, each row including five battery cells 314 connected in series, each battery cell 314 having a voltage of 3.6 volts.

With reference to FIG. 20D, the battery pack housing 298 may be provided with a plurality of, and particularly fifteen, cylindrical battery cells 322 therein to form a battery pack 326. The cylindrical battery cells 322 may have a cell diameter of 23 mm, a cell length of 70 mm, a cell volume of 29,083 mm³, a cell capacity of 4.8 Ah, a cell ACIR of 5.3 mohm, and a cell DCIR of 12.9 mohm. The battery pack 326 may have a pack capacity of 14.4 Ah, an energy of 259 Wh, an energy density of 216 Wh/L, and a volumetric packing efficiency of 36.4%. The battery pack 326 may include three groups (or “rows”) of battery cells 322 that are connected in parallel to each other, each row including five battery cells 322 connected in series, each battery cell 322 having a voltage of 3.6 volts.

With reference to FIG. 20E, the battery pack housing 298 may be provided with a plurality of, and particularly twenty, cylindrical battery cells 330 therein to form a battery pack 334. The cylindrical battery cells 330 may have a cell diameter of 21 mm, a cell length of 70 mm, a cell volume of 24,245 mm³, a cell capacity of 4.0 Ah, a cell ACIR of 4.4 mohm, and a cell DCIR of 10.7 mohm. The battery pack 334 may have a pack capacity of 16.0 Ah, an energy of 288 Wh, an energy density of 240 Wh/L, and a volumetric packing efficiency of 40.4%. The battery pack 334 may include four groups (or “rows”) of battery cells 330 that are connected in parallel to each other, each row including five battery cells 330 connected in series, each battery cell 330 having a voltage of 3.6 volts.

With reference to FIG. 20F, the battery pack housing 298 may be provided with a plurality of, and particularly twenty-five, cylindrical battery cells 338 therein to form a battery pack 342. The cylindrical battery cells 338 may have a cell diameter of 17 mm, a cell length of 70 mm, a cell volume of 15,889 mm³, a cell capacity of 2.6 Ah, a cell ACIR of 2.9 mohm, and a cell DCIR of 7.0 mohm. The battery pack 342 may have a pack capacity of 13.1 Ah, an energy of 236 Wh, an energy density of 197 Wh/L, and a volumetric packing efficiency of 33.1%. The battery pack 342 may include five groups (or “rows”) of battery cells 338 that are connected in parallel to each other, each row including five battery cells 338 connected in series, each battery cell 338 having a voltage of 3.6 volts.

Certain features of the battery packs 310, 318, 326, 334, 342 are presented in the tables below:

TABLE 8-1

| | Cell | Cell Dia. | Cell Length | Cell Volume |
|---|---|---|---|---|
| Embodiment | Config. | (mm) | (mm) | (mm\hat{ }3) |
| Battery Pack 310 | 5S1P | 40 | 70 | 87965 |
| Battery Pack 318 | 5S2P | 28 | 70 | 43103 |
| Battery Pack 326 | 5S3P | 23 | 70 | 29083 |
| Battery Pack 334 | 5S4P | 21 | 70 | 24245 |
| Battery Pack 342 | 5S5P | 17 | 70 | 15889 |

TABLE 8-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 310 | 14.5 | 16.0 | 38.9 | 14.5 |
| Battery Pack 318 | 7.1 | 7.8 | 19.1 | 14.2 |
| Battery Pack 326 | 4.8 | 5.3 | 12.9 | 14.4 |
| Battery Pack 334 | 4.0 | 4.4 | 10.7 | 16.0 |
| Battery Pack 342 | 2.6 | 2.9 | 7.0 | 13.1 |

TABLE 8-3

| | | Energy Density | Vol. Packing |
|---|---|---|---|
| Embodiment | Energy (Wh) | (Wh/L) | Efficiency %: |
| Battery Pack 310 | 261 | 218 | 36.7 |
| Battery Pack 318 | 256 | 213 | 35.9 |
| Battery Pack 326 | 259 | 216 | 36.4 |
| Battery Pack 334 | 288 | 240 | 40.4 |
| Battery Pack 342 | 236 | 197 | 33.1 |

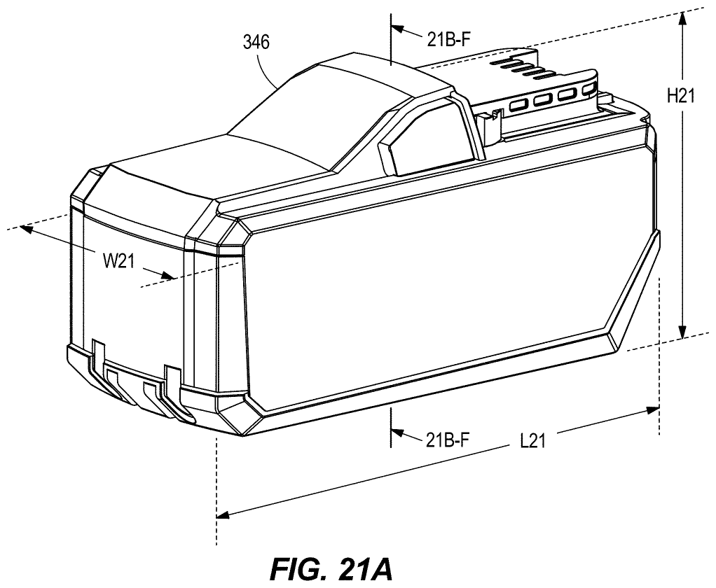

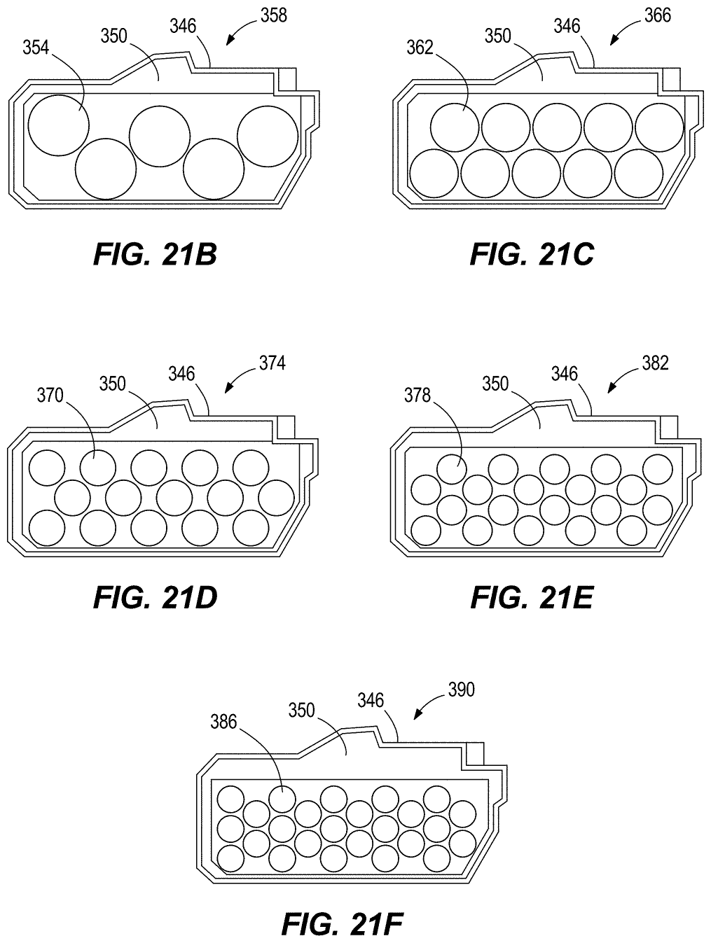

With reference to FIG. 21A, a battery pack housing 346 may have a length L21 of 197 mm, a width W21 of 86 mm, and a height H21 of 98 mm. The battery pack housing 346 may have an internal volume 350 of 1,238,485 mm³ (i.e., 1238 cm³ and 1.2 L) (FIGS. 21B-21F). These dimensions of the battery pack housing 346 are listed in the following table:

TABLE 9

| Length | Width | Height | Volume | Volume | Volume |
|---|---|---|---|---|---|
| (mm) | (mm) | (mm) | (mm\hat{ }3) | (cm\hat{ }3) | (L) |
| 197 | 86 (constant) | 98 (constant) | 1238485 | 1238 | 1.2 |

The battery pack housing 346 may have an available volume as shown in the table below:

TABLE 10

| | mm\hat{ }3 | cm\hat{ }3 | L |
|---|---|---|---|
| Available Volume: | 637209 | 637.2 | 0.64 |

With reference to FIG. 21B, the battery pack housing 346 may be provided with a plurality of, and particularly five, cylindrical battery cells 354 therein to form a battery pack 358. The cylindrical battery cells 354 may have a cell diameter of 38 mm, a cell length of 70 mm, a cell volume of 79,388 mm³, a cell capacity of 13.1 Ah, a cell ACIR of 14.4 mohm, and a cell DCIR of 35.1 mohm. The battery pack 358 may have a pack capacity of 13.1 Ah, an energy of 236 Wh, an energy density of 190 Wh/L, and a volumetric packing efficiency of 32.1%. Each cylindrical battery cell 354 within the battery pack 358 may be connected in series. As otherwise mentioned herein, a battery pack, such as the battery pack 358, may be defined by a number of groups (or, in other words, a number of “rows”) of battery cells that are connected in parallel. In the battery pack 358, since each cylindrical battery cell 354 is connected in series, the entire group of five battery cells 354 may be considered to be a single group or “row” of battery cells.

With reference to FIG. 21C, the battery pack housing 346 may be provided with a plurality of, and particularly ten, cylindrical battery cells 362 therein to form a battery pack 366. The cylindrical battery cells 362 may have a cell diameter of 30 mm, a cell length of 70 mm, a cell volume of 49,480 mm³, a cell capacity of 8.2 Ah, a cell ACIR of 9.0 mohm, and a cell DCIR of 21.9 mohm. The battery pack 366 may have a pack capacity of 16.3 Ah, an energy of 294 Wh, an energy density of 237 Wh/L, and a volumetric packing efficiency of 40.0%. The battery pack 366 may include two groups (or “rows”) of battery cells 362 that are connected in parallel to each other, each row including five battery cells 362 connected in series, each battery cell 362 having a voltage of 3.6 volts.

With reference to FIG. 21D, the battery pack housing 346 may be provided with a plurality of, and particularly fifteen, cylindrical battery cells 370 therein to form a battery pack 374. The cylindrical battery cells 370 may have a cell diameter of 23 mm, a cell length of 70 mm, a cell volume of 29,083 mm³, a cell capacity of 4.8 Ah, a cell ACIR of 5.3 mohm, and a cell DCIR of 12.9 mohm. The battery pack 374 may have a pack capacity of 14.4 Ah, an energy of 259 Wh, an energy density of 209 Wh/L, and a volumetric packing efficiency of 35.2%. The battery pack 374 may include three groups (or “rows”) of battery cells 370 that are connected in parallel to each other, each row including five battery cells 370 connected in series, each battery cell 370 having a voltage of 3.6 volts.

With reference to FIG. 21E, the battery pack housing 346 may be provided with a plurality of, and particularly twenty, cylindrical battery cells 378 therein to form a battery pack 382. The cylindrical battery cells 378 may have a cell diameter of 19 mm, a cell length of 70 mm, a cell volume of 19,847 mm³, a cell capacity of 3.3 Ah, a cell ACIR of 3.6 mohm, and a cell DCIR of 8.8 mohm. The battery pack 382 may have a pack capacity of 13.1 Ah, an energy of 236 Wh, an energy density of 190 Wh/L, and a volumetric packing efficiency of 32.1%. The battery pack 382 may include four groups (or “rows”) of battery cells 378 that are connected in parallel to each other, each row including five battery cells 378 connected in series, each battery cell 378 having a voltage of 3.6 volts.

With reference to FIG. 21F, the battery pack housing 346 may be provided with a plurality of, and particularly twenty-five, cylindrical battery cells 386 therein to form a battery pack 390. The cylindrical battery cells 386 may have a cell diameter of 17 mm, a cell length of 70 mm, a cell volume of 15,889 mm³, a cell capacity of 2.6 Ah, a cell ACIR of 2.9 mohm, and a cell DCIR of 7.0 mohm. The battery pack 390 may have a pack capacity of 13.1 Ah, an energy of 236 Wh, an energy density of 190 Wh/L, and a volumetric packing efficiency of 32.1%. The battery pack 390 may include five groups (or “rows”) of battery cells 386 that are connected in parallel to each other, each row including five battery cells 386 connected in series, each battery cell 386 having a voltage of 3.6 volts.

Certain features of the battery packs 358, 366, 374, 382, 390 are presented in the tables below:

TABLE 11-1

| | Cell | Cell Dia. | Cell Length | Cell Volume |
|---|---|---|---|---|
| Embodiment | Config. | (mm) | (mm) | (mm\hat{ }3) |
| Battery Pack 358 | 5S1P | 38 | 70 | 79388 |
| Battery Pack 366 | 5S2P | 30 | 70 | 49480 |
| Battery Pack 374 | 5S3P | 23 | 70 | 29083 |
| Battery Pack 382 | 5S4P | 19 | 70 | 19847 |
| Battery Pack 390 | 5S5P | 17 | 70 | 15889 |

TABLE 11-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 358 | 13.1 | 14.4 | 35.1 | 13.1 |
| Battery Pack 366 | 8.2 | 9.0 | 21.9 | 16.3 |
| Battery Pack 374 | 4.8 | 5.3 | 12.9 | 14.4 |
| Battery Pack 382 | 3.3 | 3.6 | 8.8 | 13.1 |
| Battery Pack 390 | 2.6 | 2.9 | 7.0 | 13.1 |

TABLE 11-3

| | | Energy Density | Vol. Packing |
|---|---|---|---|
| Embodiment | Energy (Wh) | (Wh/L) | Efficiency %: |
| Battery Pack 358 | 236 | 190 | 32.1 |
| Battery Pack 366 | 294 | 237 | 40.0 |
| Battery Pack 374 | 259 | 209 | 35.2 |
| Battery Pack 382 | 236 | 190 | 32.1 |
| Battery Pack 390 | 236 | 190 | 32.1 |

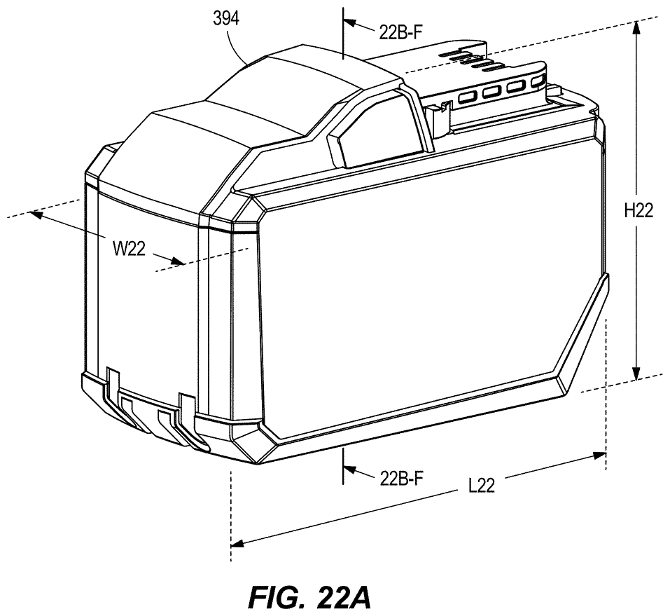

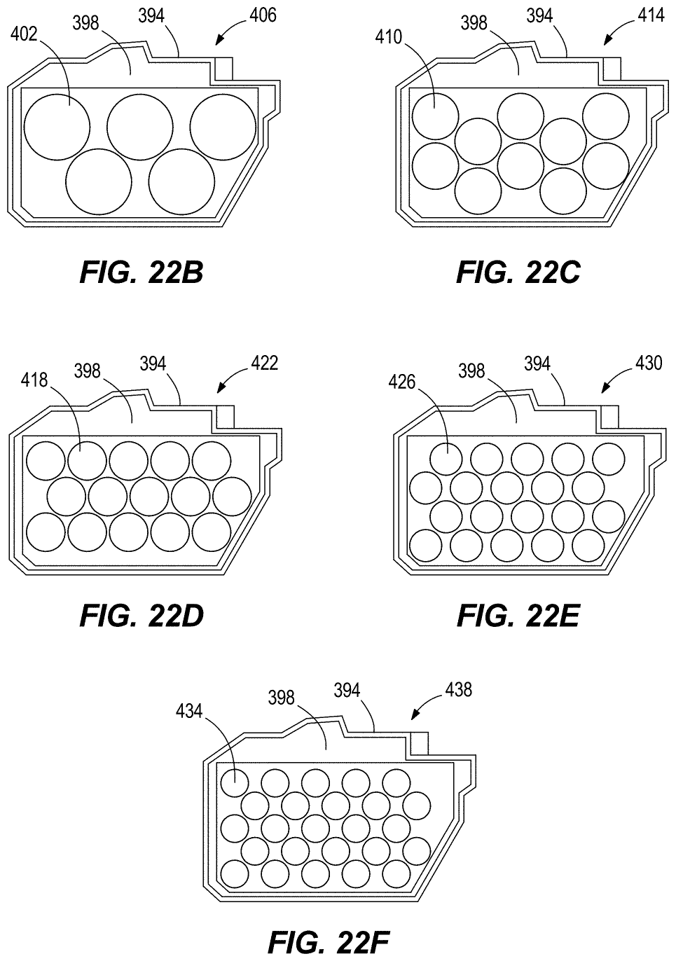

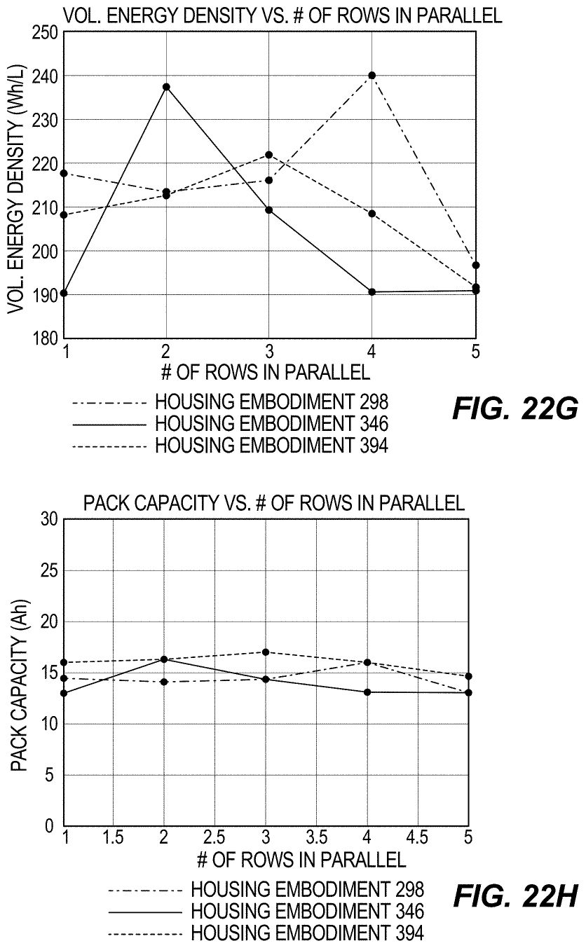

With reference to FIG. 22A, a battery pack housing 394 may have a length L22 of 176 mm, a width W22 of 86 mm, and a height H22 of 118 mm. The battery pack housing 394 may have an internal volume 398 of 1,381,007 mm³ (i.e., 1,381 cm³ and 1.4 L) (FIG. 22B-22F). These dimensions of the battery pack housing 394 are listed in the following table:

TABLE 12

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 176 | 86 | 118 | 1381007 | 1381 | 1.4 |

The battery pack housing 394 may have an available volume as shown in the figure below:

TABLE 13

| | MM\hat{ }3 | CM\hat{ }3 | L |
|---|---|---|---|
| AVAILABLE | 731537 | 731.5 | 0.73 |
| VOLUME: | | | |

With reference to FIG. 22B, the battery pack housing 394 may be provided with a plurality of, and particularly five, cylindrical battery cells 402 therein to form a battery pack 406. The cylindrical battery cells 402 may have a cell diameter of 42 mm, a cell length of 70 mm, a cell volume of 96,981 mm³, a cell capacity of 16 Ah, a cell ACIR of 17.6 mohm, and a cell DCIR of 42.9 mohm. The battery pack 406 may have a pack capacity of 16 Ah, an energy of 288 Wh, an energy density of 209 Wh/L, and a volumetric packing efficiency of 35.1%. Each cylindrical battery cell 402 within the battery pack 406 may be connected in series. As otherwise mentioned herein, a battery pack, such as the battery pack 406, may be defined by a number of groups (or, in other words, a number of “rows”) of battery cells that are connected in parallel. In the battery pack 406, since each cylindrical battery cell 402 is connected in series, the entire group of five battery cells 402 may be considered to be a single group or “row” of battery cells 402.

With reference to FIG. 22C, the battery pack housing 394 may be provided with a plurality of, and particularly ten, cylindrical battery cells 410 therein to form a battery pack 414. The cylindrical battery cells 410 may have a cell diameter of 30 mm, a cell length of 70 mm, a cell volume of 49,480 mm³, a cell capacity of 8.2 Ah, a cell ACIR of 9.0 mohm, and a cell DCIR of 21.9 mohm. The battery pack 414 may have a pack capacity of 16.3 Ah, an energy of 294 Wh, an energy density of 213 Wh/L, and a volumetric packing efficiency of 35.8%. The battery pack 414 may include two groups (or “rows”) of battery cells 410 that are connected in parallel to each other, each row including five battery cells 410 connected in series, each battery cell 410 having a voltage of 3.6 volts.

With reference to FIG. 22D, the battery pack housing 394 may be provided with a plurality of, and particularly fifteen, cylindrical battery cells 418 therein to form a battery pack 422. The cylindrical battery cells 418 may have a cell diameter of 25 mm, a cell length of 70 mm, a cell volume of 34,361 mm³, a cell capacity of 5.7 Ah, a cell ACIR of 6.2 mohm, and a cell DCIR of 15.2 mohm. The battery pack 422 may have a pack capacity of 17.0 Ah, an energy of 306 Wh, an energy density of 222 Wh/L, and a volumetric packing efficiency of 37.3%. The battery pack 422 may include three groups (or “rows”) of battery cells 418 that are connected in parallel to each other, each row including five battery cells 418 connected in series, each battery cell 418 having a voltage of 3.6 volts.

With reference to FIG. 22E, the battery pack housing 394 may be provided with a plurality of, and particularly twenty, cylindrical battery cells 426 therein to form a battery pack 430. The cylindrical battery cells 426 may have a cell diameter of 21 mm, a cell length of 70 mm, a cell volume of 24,245 mm³, a cell capacity of 4.0 Ah, a cell ACIR of 4.4 mohm, and a cell DCIR of 10.7 mohm. The battery pack 430 may have a pack capacity of 16.0 Ah, an energy of 288 Wh, an energy density of 209 Wh/L, and a volumetric packing efficiency of 35.1%. The battery pack 430 may include four groups (or “rows”) of battery cells 426 that are connected in parallel to each other, each row including five battery cells 426 connected in series, each battery cell 426 having a voltage of 3.6 volts.

With reference to FIG. 22F, the battery pack housing 394 may be provided with a plurality of, and particularly twenty-five, cylindrical battery cells 434 therein to form a battery pack 438. The cylindrical battery cells 434 may have a cell diameter of 18 mm, a cell length of 70 mm, a cell volume of 17,813 mm³, a cell capacity of 2.9 Ah, a cell ACIR of 3.2 mohm, and a cell DCIR of 7.9 mohm. The battery pack 438 may have a pack capacity of 14.7 Ah, an energy of 264 Wh, an energy density of 192 Wh/L, and a volumetric packing efficiency of 32.2%. The battery pack 438 may include five groups (or “rows”) of battery cells 434 that are connected in parallel to each other, each row including five battery cells 434 connected in series, each battery cell 434 having a voltage of 3.6 volts.

Certain features of the battery packs 406, 414, 422, 430, 438 are presented in the tables below:

TABLE 14-1

| | Cell | Cell Dia. | Cell Length | Cell Volume |
|---|---|---|---|---|
| Embodiment | Config. | (mm) | (mm) | (mm\hat{ }3) |
| Battery Pack 406 | 5S1P | 42 | 70 | 96981 |
| Battery Pack 414 | 5S2P | 30 | 70 | 49480 |
| Battery Pack 422 | 5S3P | 25 | 70 | 34361 |
| Battery Pack 430 | 5S4P | 21 | 70 | 24245 |
| Battery Pack 438 | 5S5P | 18 | 70 | 17813 |

TABLE 14-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 406 | 16 | 17.6 | 42.9 | 16 |
| Battery Pack 414 | 8.2 | 9.0 | 21.9 | 16.3 |
| Battery Pack 422 | 5.7 | 6.2 | 15.2 | 17.0 |
| Battery Pack 430 | 4.0 | 4.4 | 10.7 | 16.0 |
| Battery Pack 438 | 2.9 | 3.2 | 7.9 | 14.7 |

TABLE 14-3

| | | Energy Density | Vol. Packing |
|---|---|---|---|
| Embodiment | Energy (Wh) | (Wh/L) | Efficiency %: |
| Battery Pack 406 | 288 | 209 | 35.1 |
| Battery Pack 414 | 294 | 213 | 35.8 |
| Battery Pack 422 | 306 | 222 | 37.3 |
| Battery Pack 430 | 288 | 209 | 35.1 |
| Battery Pack 438 | 264 | 192 | 32.2 |

A summary of certain features of the battery packs 310, 318, 326, 334, 342, 358, 366, 374, 382, 390, 406, 414, 422, 430, 438 are presented in the table below:

TABLE 15

| | | | | | VOL. |
|---|---|---|---|---|---|
| | BATTERY | | # OF ROWS | PACK | ENERGY |
| HOUSING | PACK | 5S4P | IN | CAPACITY | DENSITY |
| EMBODIMENT | EMBODIMENT | CONFIGURATION: | PARALLEL: | (AH): | (WH/L): |
| 298 | 310 | 5S1P | 1 | 14.5 | 218 |
| | 318 | 5S2P | 2 | 14.2 | 213 |
| | 326 | 5S3P | 3 | 14.4 | 216 |
| | 334 | 5S4P | 4 | 16.0 | 240 |
| | 342 | 5S5P | 5 | 13.1 | 197 |
| 346 | 358 | 5S1P | 1 | 13.1 | 190 |
| | 366 | 5S2P | 2 | 16.3 | 237 |
| | 374 | 5S3P | 3 | 14.4 | 209 |
| | 382 | 5S4P | 4 | 13.1 | 190 |
| | 390 | 5S5P | 5 | 13.1 | 190 |
| 394 | 406 | 5S1P | 1 | 16.0 | 209 |
| | 414 | 5S2P | 2 | 16.3 | 213 |
| | 422 | 5S3P | 3 | 17.0 | 222 |
| | 430 | 5S4P | 4 | 16.0 | 209 |
| | 438 | 5S5P | 5 | 14.7 | 192 |

With reference to FIG. 22G, volumetric energy density is plotted as a function of the number of rows of battery cells in parallel for the various disclosed embodiments of battery packs for the battery pack housings 298, 346, 394.

With reference to FIG. 22H, a pack capacity is plotted as a function of the number of rows of battery cells in parallel for the various disclosed embodiments of battery packs for the battery pack housings 298, 346, 394.

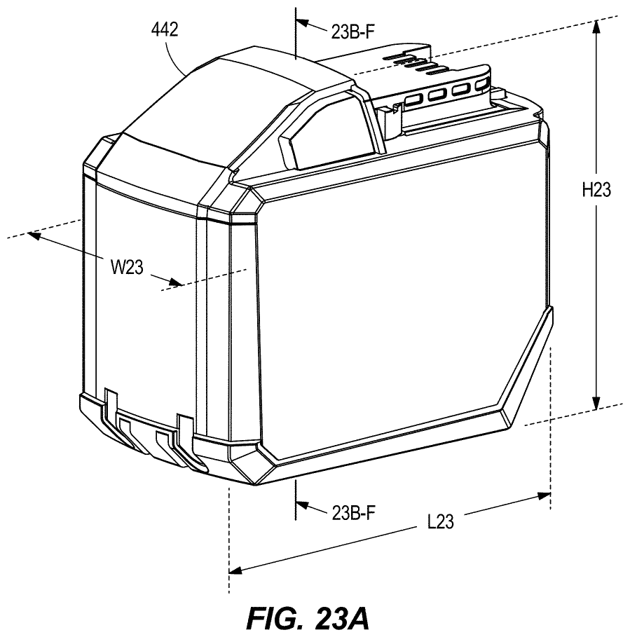

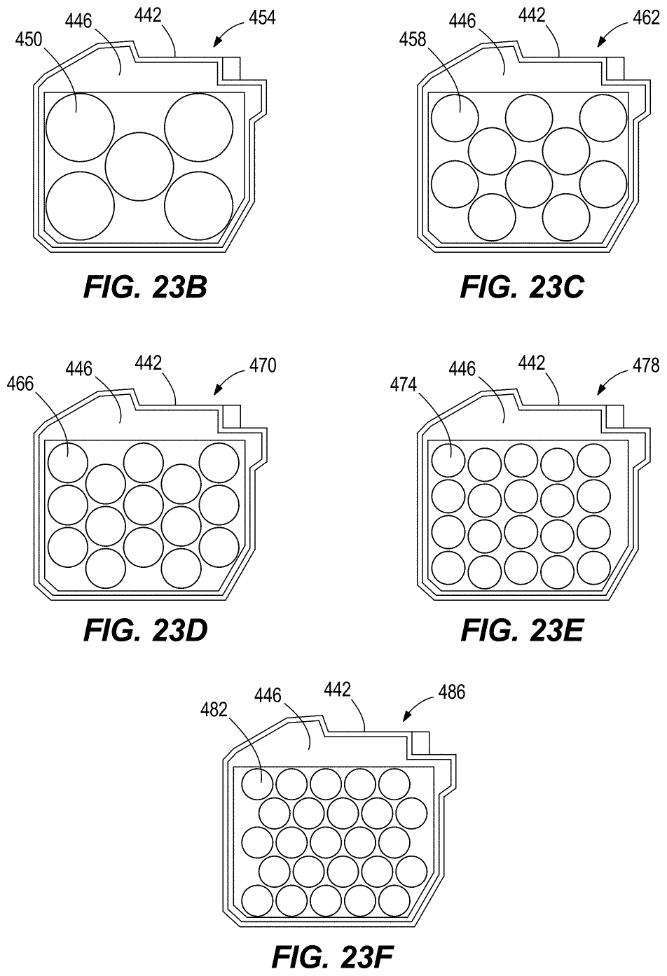

With reference to FIG. 23A, a battery pack housing 442 may have a length of 153.3 mm, a width of 86 mm, and a height of 137.6 mm. The battery pack housing 442 may have an internal volume 446 of 1,441,606 mm³ (i.e., 1,442 cm³ and 1.44161 L) (FIGS. 20B-20F). These dimensions of the battery pack housing 442 are listed in the following table:

TABLE 16

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 153.3 | 86 | 137.6 | 1441606 | 1442 | 1.44161 |

With reference to FIG. 23B, the battery pack housing 442 may be provided with a plurality of, and particularly five, cylindrical battery cells 450 therein to form a battery pack 454. The cylindrical battery cells 450 may have a cell diameter of 45 mm, a cell length of 70 mm, a cell volume of 111,330 mm³, a cell capacity of 18.4 Ah, a cell ACIR of 20.2 mohm, and a cell DCIR of 49.3 mohm. The battery pack 454 may have a pack capacity of 18.4 Ah, an energy of 331 Wh, an energy density of 229 Wh/L, and a volumetric packing efficiency of 38.6%. Each cylindrical battery cell 450 within the battery pack 454 may be connected in series. A battery pack, such as the battery pack 454, may be defined by a number of groups (or, in other words, a number of “rows”) of battery cells that are connected in parallel. In the battery pack 454, since each cylindrical battery cell 450 is connected in series, the entire group of five battery cells 450 may be considered to be a single group or “row” of battery cells 450.

With reference to FIG. 23C, the battery pack housing 442 may be provided with a plurality of, and particularly ten, cylindrical battery cells 458 therein to form a battery pack 462. The cylindrical battery cells 458 may have a cell diameter of 31 mm, a cell length of 70 mm, a cell volume of 52,834 mm³, a cell capacity of 8.7 Ah, a cell ACIR of 9.6 mohm, and a cell DCIR of 23.4 mohm. The battery pack 462 may have a pack capacity of 17.4 Ah, an energy of 314 Wh, an energy density of 218 Wh/L, and a volumetric packing efficiency of 36.6%. The battery pack 462 may include two groups (or “rows”) of battery cells 458 that are connected in parallel to each other, each row including five battery cells 458 connected in series, each battery cell 458 having a voltage of 3.6 volts.

With reference to FIG. 23D, the battery pack housing 442 may be provided with a plurality of, and particularly fifteen, cylindrical battery cells 466 therein to form a battery pack 470. The cylindrical battery cells 466 may have a cell diameter of 27 mm, a cell length of 70 mm, a cell volume of 40,079 mm³, a cell capacity of 6.6 Ah, a cell ACIR of 7.3 mohm, and a cell DCIR of 17.7 mohm. The battery pack 470 may have a pack capacity of 19.8 Ah, an energy of 357 Wh, an energy density of 248 Wh/L, and a volumetric packing efficiency of 41.7%. The battery pack 470 may include three groups (or “rows”) of battery cells 466 that are connected in parallel to each other, each row including five battery cells 466 connected in series, each battery cell 466 having a voltage of 3.6 volts.

With reference to FIG. 23E, the battery pack housing 442 may be provided with a plurality of, and particularly twenty, cylindrical battery cells 474 therein to form a battery pack 478. The cylindrical battery cells 474 may have a cell diameter of 22 mm, a cell length of 70 mm, a cell volume of 26,609 mm³, a cell capacity of 4.4 Ah, a cell ACIR of 4.8 mohm, and a cell DCIR of 11.8 mohm. The battery pack 478 may have a pack capacity of 17.6 Ah, an energy of 316 Wh, an energy density of 219 Wh/L, and a volumetric packing efficiency of 36.9%. The battery pack 478 may include four groups (or “rows”) of battery cells 474 that are connected in parallel to each other, each row including five battery cells 474 connected in series, each battery cell 474 having a voltage of 3.6 volts.

With reference to FIG. 23F, the battery pack housing 442 may be provided with a plurality of, and particularly twenty-five, cylindrical battery cells 482 therein to form a battery pack 486. The cylindrical battery cells 482 may have a cell diameter of 21 mm, a cell length of 70 mm, a cell volume of 24,245 mm³, a cell capacity of 4.0 Ah, a cell ACIR of 4.4 mohm, and a cell DCIR of 10.7 mohm. The battery pack 486 may have a pack capacity of 20.0 Ah, an energy of 360 Wh, an energy density of 250 Wh/L, and a volumetric packing efficiency of 42.0%. The battery pack 486 may include five groups (or “rows”) of battery cells 482 that are connected in parallel to each other, each row including five battery cells 482 connected in series, each battery cell 482 having a voltage of 3.6 volts.

Certain features of the battery packs 454, 462, 470, 478, 486 are presented in the tables below:

TABLE 17-1

| | Cell | Cell Dia. | Cell Length | Cell Volume |
|---|---|---|---|---|
| Embodiment | Config. | (mm) | (mm) | (mm\hat{ }3) |
| Battery Pack 454 | 5S1P | 45 | 70 | 111330 |
| Battery Pack 462 | 5S2P | 31 | 70 | 52834 |
| Battery Pack 470 | 5S3P | 27 | 70 | 40079 |
| Battery Pack 478 | 5S4P | 22 | 70 | 26609 |
| Battery Pack 486 | 5S5P | 21 | 70 | 24245 |

TABLE 17-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 454 | 18.4 | 20.2 | 49.3 | 18.4 |
| Battery Pack 462 | 8.7 | 9.6 | 23.4 | 17.4 |
| Battery Pack 470 | 6.6 | 7.3 | 17.7 | 19.8 |
| Battery Pack 478 | 4.4 | 4.8 | 11.8 | 17.6 |
| Battery Pack 486 | 4.0 | 4.4 | 10.7 | 20.0 |

TABLE 17-3

| | | Energy Density | Vol. Packing |
|---|---|---|---|
| Embodiment | Energy (Wh) | (Wh/L) | Efficiency %: |
| Battery Pack 454 | 331 | 229 | 38.6 |
| Battery Pack 462 | 314 | 218 | 36.6 |
| Battery Pack 470 | 357 | 248 | 41.7 |
| Battery Pack 478 | 316 | 219 | 36.9 |
| Battery Pack 486 | 360 | 250 | 42.0 |

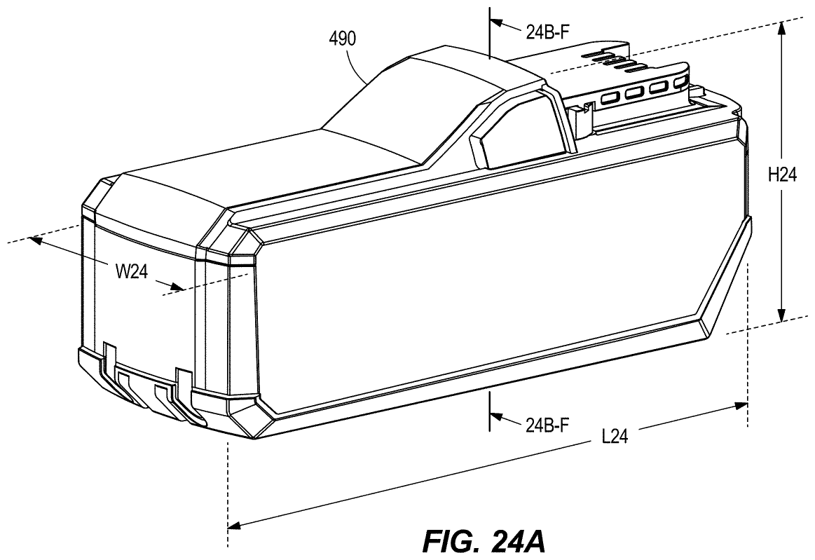

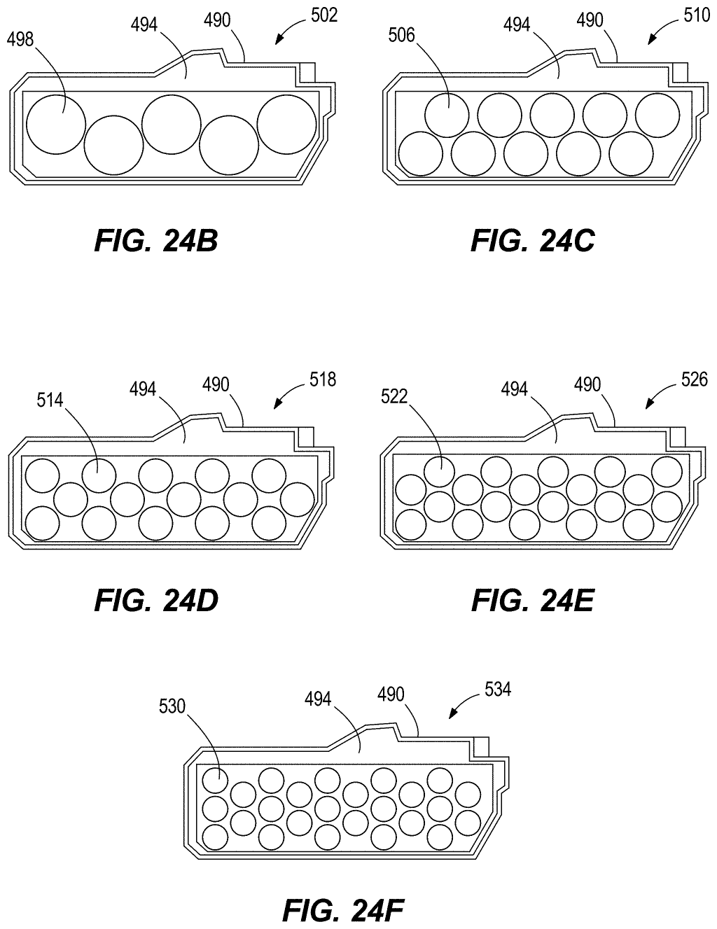

With reference to FIG. 24A, a battery pack housing 490 may have a length L24 of 232.1 mm, a width W24 of 86 mm, and a height H24 of 97.9 mm. The battery pack housing 490 may have an internal volume 494 of 1,238,485 mm³ (i.e., 1238 cm³ and 1.2 L) (FIGS. 24B-24F). These dimensions of the battery pack housing 490 are listed in the following table:

TABLE 18

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 232.1 | 86 | 97.9 | 1481474 | 1481 | 1.5 |

With reference to FIG. 24B, the battery pack housing 490 may be provided with a plurality of, and particularly five, cylindrical battery cells 498 therein to form a battery pack 502. The cylindrical battery cells 498 may have a cell diameter of 42 mm, a cell length of 70 mm, a cell volume of 96,981 mm³, a cell capacity of 16 Ah, a cell ACIR of 17.6 mohm, and a cell DCIR of 42.9 mohm. The battery pack 502 may have a pack capacity of 16 Ah, an energy of 288 Wh, an energy density of 194 Wh/L, and a volumetric packing efficiency of 32.7%. Each cylindrical battery cell 498 within the battery pack 502 may be connected in series. As otherwise mentioned herein, a battery pack, such as the battery pack 502, may be defined by a number of groups (or, in other words, a number of “rows”) of battery cells that are connected in parallel. In the battery pack 502, since each cylindrical battery cell 498 is connected in series, the entire group of five battery cells 498 may be considered to be a single group or “row” of battery cells 498.

With reference to FIG. 24C, the battery pack housing 490 may be provided with a plurality of, and particularly ten, cylindrical battery cells 506 therein to form a battery pack 510. The cylindrical battery cells 506 may have a cell diameter of 31 mm, a cell length of 70 mm, a cell volume of 52,834 mm³, a cell capacity of 8.7 Ah, a cell ACIR of 9.6 mohm, and a cell DCIR of 23.4 mohm. The battery pack 510 may have a pack capacity of 17.4 Ah, an energy of 314 Wh, an energy density of 212 Wh/L, and a volumetric packing efficiency of 35.7%. The battery pack 510 may include two groups (or “rows”) of battery cells 506 that are connected in parallel to each other, each row including five battery cells 506 connected in series, each battery cell 506 having a voltage of 3.6 volts.

With reference to FIG. 24D, the battery pack housing 490 may be provided with a plurality of, and particularly fifteen, cylindrical battery cells 514 therein to form a battery pack 518. The cylindrical battery cells 514 may have a cell diameter of 24 mm, a cell length of 70 mm, a cell volume of 31,667 mm³, a cell capacity of 5.2 Ah, a cell ACIR of 5.7 mohm, and a cell DCIR of 14.0 mohm. The battery pack 518 may have a pack capacity of 15.7 Ah, an energy of 282 Wh, an energy density of 190 Wh/L, and a volumetric packing efficiency of 32.1%. The battery pack 518 may include three groups (or “rows”) of battery cells 514 that are connected in parallel to each other, each row including five battery cells 514 connected in series, each battery cell 514 having a voltage of 3.6 volts.

With reference to FIG. 24E, the battery pack housing 490 may be provided with a plurality of, and particularly twenty, cylindrical battery cells 522 therein to form a battery pack 526. The cylindrical battery cells 522 may have a cell diameter of 22 mm, a cell length of 70 mm, a cell volume of 26,609 mm³, a cell capacity of 4.4 Ah, a cell ACIR of 4.8 mohm, and a cell DCIR of 11.8 mohm. The battery pack 526 may have a pack capacity of 17.6 Ah, an energy of 316 Wh, an energy density of 213 Wh/L, and a volumetric packing efficiency of 35.9%. The battery pack 526 may include four groups (or “rows”) of battery cells 522 that are connected in parallel to each other, each row including five battery cells 522 connected in series, each battery cell 522 having a voltage of 3.6 volts.

With reference to FIG. 24F, the battery pack housing 490 may be provided with a plurality of, and particularly twenty-five, cylindrical battery cells 530 therein to form a battery pack 534. The cylindrical battery cells 530 may have a cell diameter of 19 mm, a cell length of 70 mm, a cell volume of 19,847 mm³, a cell capacity of 3.3 Ah, a cell ACIR of 3.6 mohm, and a cell DCIR of 8.8 mohm. The battery pack 534 may have a pack capacity of 16.4 Ah, an energy of 295 Wh, an energy density of 199 Wh/L, and a volumetric packing efficiency of 33.5%. The battery pack 534 may include five groups (or “rows”) of battery cells 530 that are connected in parallel to each other, each row including five battery cells 530 connected in series, each battery cell 530 having a voltage of 3.6 volts.

Certain features of the battery packs 502, 510, 518, 526, 534 are presented in the tables below:

TABLE 18-1

| | Cell | Cell Dia. | Cell Length | Cell Volume |
|---|---|---|---|---|
| Embodiment | Config. | (mm) | (mm) | (mm\hat{ }3) |
| Battery Pack 502 | 5S1P | 42 | 70 | 96981 |
| Battery Pack 510 | 5S2P | 31 | 70 | 52834 |
| Battery Pack 518 | 5S3P | 24 | 70 | 31667 |
| Battery Pack 526 | 5S4P | 22 | 70 | 26609 |
| Battery Pack 534 | 5S5P | 19 | 70 | 19847 |

TABLE 18-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 502 | 16 | 17.6 | 42.9 | 16 |
| Battery Pack 510 | 8.7 | 9.6 | 23.4 | 17.4 |
| Battery Pack 518 | 5.2 | 5.7 | 14.0 | 15.7 |
| Battery Pack 526 | 4.4 | 4.8 | 11.8 | 17.6 |
| Battery Pack 534 | 3.3 | 3.6 | 8.8 | 16.4 |

TABLE 18-3

| | | Energy Density | Vol. Packing |
|---|---|---|---|
| Embodiment | Energy (Wh) | (Wh/L) | Efficiency %: |
| Battery Pack 502 | 288 | 194 | 32.7 |
| Battery Pack 510 | 314 | 212 | 35.7 |
| Battery Pack 518 | 282 | 190 | 32.1 |
| Battery Pack 526 | 316 | 213 | 35.9 |
| Battery Pack 534 | 295 | 199 | 33.5 |

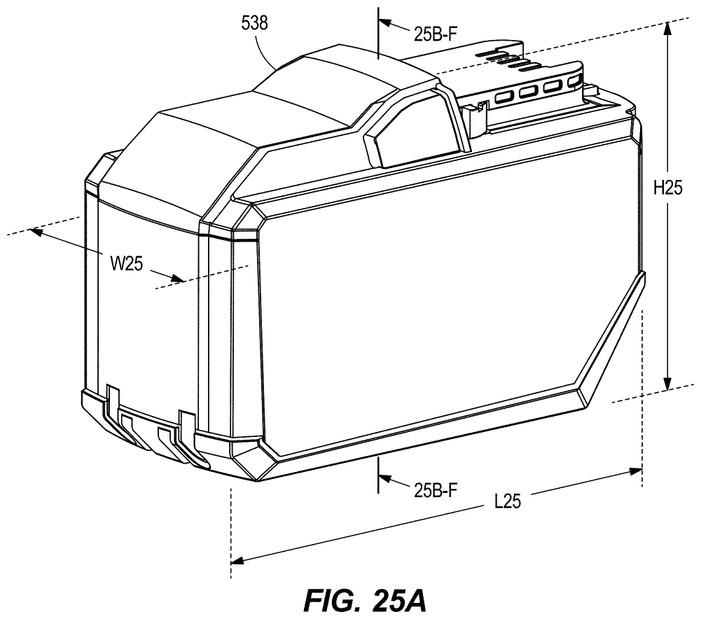

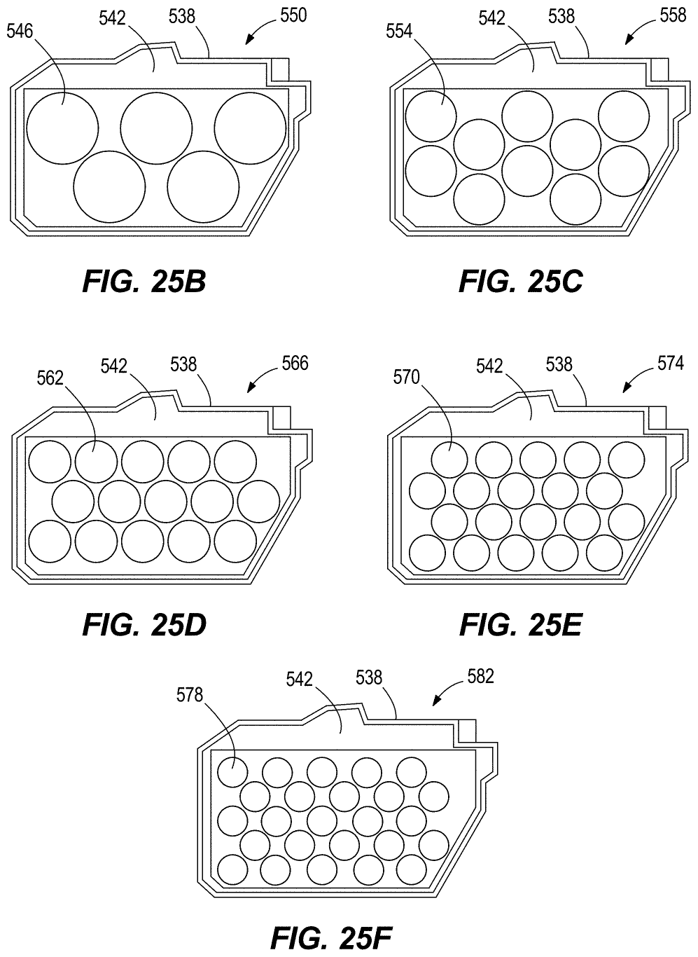

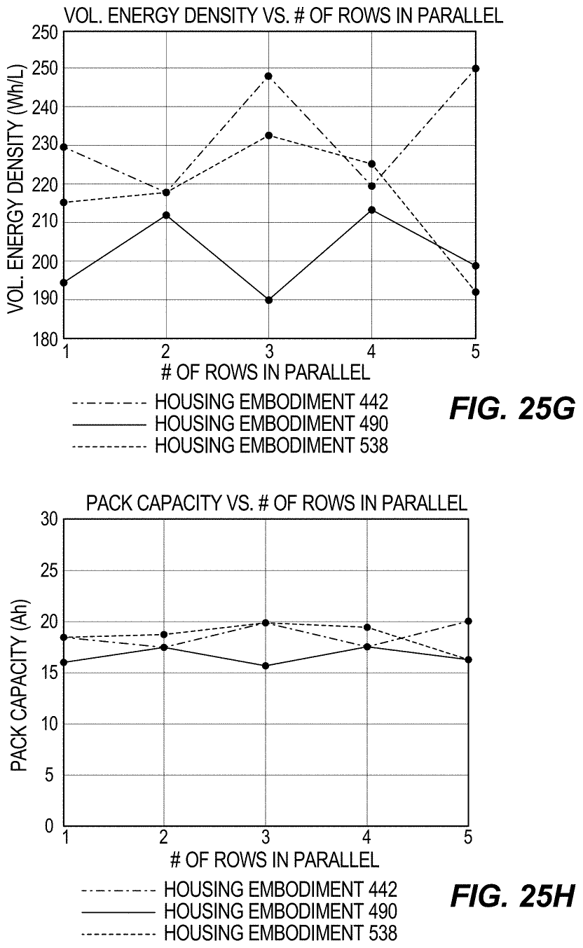

With reference to FIG. 25A, a battery pack housing 538 may have a length L25 of 189.3159204 mm, a width W25 of 86 mm, and a height H25 of 122.1800255 mm. The battery pack housing 538 may have an internal volume 542 of 1,535,552 mm³ (i.e., 1,536 cm³ and 1.5 L) (FIGS. 25B-25F). These dimensions of the battery pack housing 538 are listed in the following table:

TABLE 19

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 189.3159204 | 86 | 122.1800255 | 1535552 | 1536 | 1.5 |

With reference to FIG. 25B, the battery pack housing 538 may be provided with a plurality of, and particularly five, cylindrical battery cells 546 therein to form a battery pack 550. The cylindrical battery cells 546 may have a cell diameter of 45 mm, a cell length of 70 mm, a cell volume of 111,330 mm³, a cell capacity of 18.4 Ah, a cell ACIR of 20.2 mohm, and a cell DCIR of 49.3 mohm. The battery pack 550 may have a pack capacity of 18.4 Ah, an energy of 331 Wh, an energy density of 215 Wh/L, and a volumetric packing efficiency of 36.3%. Each cylindrical battery cell 546 within the battery pack 550 may be connected in series. As otherwise mentioned herein, a battery pack, such as the battery pack 550, may be defined by a number of groups (or, in other words, a number of “rows”) of battery cells that are connected in parallel. In the battery pack 550, since each cylindrical battery cell 546 is connected in series, the entire group of five battery cells 546 may be considered to be a single group or “row” of battery cells 546.

With reference to FIG. 25C, the battery pack housing 538 may be provided with a plurality of, and particularly ten, cylindrical battery cells 554 therein to form a battery pack 558. The cylindrical battery cells 554 may have a cell diameter of 32 mm, a cell length of 70 mm, a cell volume of 56,297 mm³, a cell capacity of 9.3 Ah, a cell ACIR of 10.2 mohm, and a cell DCIR of 24.9 mohm. The battery pack 558 may have a pack capacity of 18.6 Ah, an energy of 334 Wh, an energy density of 218 Wh/L, and a volumetric packing efficiency of 36.7%. The battery pack 558 may include two groups (or “rows”) of battery cells 554 that are connected in parallel to each other, each row including five battery cells 554 connected in series, each battery cell 554 having a voltage of 3.6 volts.

With reference to FIG. 25D, the battery pack housing 538 may be provided with a plurality of, and particularly fifteen, cylindrical battery cells 562 therein to form a battery pack 566. The cylindrical battery cells 562 may have a cell diameter of 27 mm, a cell length of 70 mm, a cell volume of 40,079 mm³, a cell capacity of 6.6 Ah, a cell ACIR of 7.3 mohm, and a cell DCIR of 17.7 mohm. The battery pack 566 may have a pack capacity of 19.8 Ah, an energy of 357 Wh, an energy density of 233 Wh/L, and a volumetric packing efficiency of 39.2%. The battery pack 566 may include three groups (or “rows”) of battery cells 562 that are connected in parallel to each other, each row including five battery cells 562 connected in series, each battery cell 562 having a voltage of 3.6 volts.

With reference to FIG. 25E, the battery pack housing 538 may be provided with a plurality of, and particularly twenty, cylindrical battery cells 570 therein to form a battery pack 574. The cylindrical battery cells 570 may have a cell diameter of 23 mm, a cell length of 70 mm, a cell volume of 29,083 mm³, a cell capacity of 4.8 Ah, a cell ACIR of 5.3 mohm, and a cell DCIR of 12.9 mohm. The battery pack 574 may have a pack capacity of 19.2 Ah, an energy of 345 Wh, an energy density of 225 Wh/L, and a volumetric packing efficiency of 37.9%. The battery pack 570 may include four groups (or “rows”) of battery cells 570 that are connected in parallel to each other, each row including five battery cells 570 connected in series, each battery cell 570 having a voltage of 3.6 volts.

With reference to FIG. 25F, the battery pack housing 538 may be provided with a plurality of, and particularly twenty-five, cylindrical battery cells 578 therein to form a battery pack 582. The cylindrical battery cells 578 may have a cell diameter of 19 mm, a cell length of 70 mm, a cell volume of 19,847 mm³, a cell capacity of 3.3 Ah, a cell ACIR of 3.6 mohm, and a cell DCIR of 8.8 mohm. The battery pack 582 may have a pack capacity of 16.4 Ah, an energy of 295 Wh, an energy density of 192 Wh/L, and a volumetric packing efficiency of 32.3%. The battery pack 582 may include five groups (or “rows”) of battery cells 578 that are connected in parallel to each other, each row including five battery cells 578 connected in series, each battery cell 578 having a voltage of 3.6 volts.

Certain features of the battery packs 550, 558, 566, 574, 582 are presented in the tables below:

TABLE 20-1

| | Cell | Cell Dia. | Cell Length | Cell Volume |
|---|---|---|---|---|
| Embodiment | Config. | (mm) | (mm) | (mm\hat{ }3) |
| Battery Pack 550 | 5S1P | 45 | 70 | 111330 |
| Battery Pack 558 | 5S2P | 32 | 70 | 56297 |
| Battery Pack 566 | 5S3P | 27 | 70 | 40079 |
| Battery Pack 574 | 5S4P | 23 | 70 | 29083 |
| Battery Pack 582 | 5S5P | 19 | 70 | 19847 |

TABLE 20-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 550 | 18.4 | 20.2 | 49.3 | 18.4 |
| Battery Pack 558 | 9.3 | 10.2 | 24.9 | 18.6 |
| Battery Pack 566 | 6.6 | 7.3 | 17.7 | 19.8 |
| Battery Pack 574 | 4.8 | 5.3 | 12.9 | 19.2 |
| Battery Pack 582 | 3.3 | 3.6 | 8.8 | 16.4 |

TABLE 20-3

| | | Energy Density | Vol. Packing |
|---|---|---|---|
| Embodiment | Energy (Wh) | (Wh/L) | Efficiency %: |
| Battery Pack 550 | 331 | 215 | 36.3 |
| Battery Pack 558 | 334 | 218 | 36.7 |
| Battery Pack 566 | 357 | 233 | 39.2 |
| Battery Pack 574 | 345 | 225 | 37.9 |
| Battery Pack 582 | 295 | 192 | 32.3 |

A summary of certain features of the battery packs 454, 462, 470, 478, 486, 502, 510, 518, 526, 534, 550, 558, 566, 574, 582 are presented in the table below:

TABLE 21

| | | | | | VOL. |
|---|---|---|---|---|---|
| | BATTERY | | # OF ROWS | PACK | ENERGY |
| HOUSING | PACK | 5S5P | IN | CAPACITY | DENSITY |
| EMBODIMENT | EMBODIMENT | CONFIGURATION: | PARALLEL: | (AH): | (WH/L): |
| 442 | 454 | 5S1P | 1 | 18.4 | 229 |
| | 462 | 5S2P | 2 | 17.4 | 218 |
| | 470 | 5S3P | 3 | 19.8 | 248 |
| | 478 | 5S4P | 4 | 17.6 | 219 |
| | 486 | 5S5P | 5 | 20.0 | 250 |
| 490 | 502 | 5S1P | 1 | 16.0 | 194 |
| | 510 | 5S2P | 2 | 17.4 | 212 |
| | 518 | 5S3P | 3 | 15.7 | 190 |
| | 526 | 5S4P | 4 | 17.6 | 213 |
| | 534 | 5S5P | 5 | 16.4 | 199 |
| 538 | 550 | 5S1P | 1 | 18.4 | 215 |
| | 558 | 5S2P | 2 | 18.6 | 218 |
| | 566 | 5S3P | 3 | 19.8 | 233 |
| | 574 | 5S4P | 4 | 19.2 | 225 |
| | 582 | 5S5P | 5 | 16.4 | 192 |

With reference to FIG. 25G, volumetric energy density is plotted as a function of the number of rows of battery cells in parallel for the various disclosed embodiments of battery packs for the battery pack housings 442, 490, 538.

With reference to FIG. 25H, a pack capacity is plotted as a function of the number of rows of battery cells in parallel for the various disclosed embodiments of battery packs for the battery pack housings 442, 490, 538.

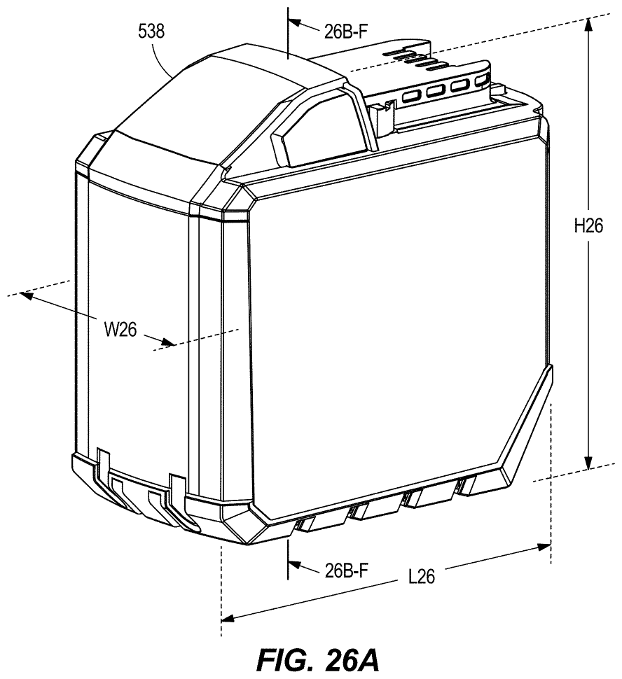

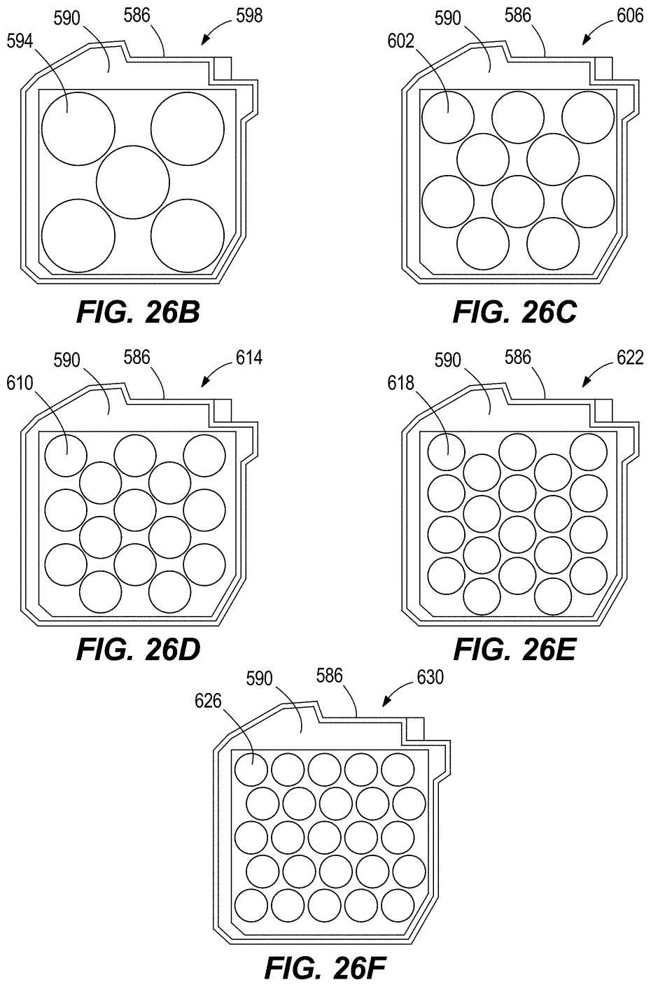

With reference to FIG. 26A, a battery pack housing 586 may have a length L26 of 151.125 mm, a width W26 of 86 mm, and a height H26 of 161.6798 mm. The battery pack housing 586 may have an internal volume 590 of 1,714,569 mm³ (i.e., 1,715 cm³ and 1.715 L) (FIGS. 26B-26F). These dimensions of the battery pack housing 586 are listed in the following table:

TABLE 22

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 151.125 | 86 | 161.6798 | 1714569 | 1715 | 1.715 |

With reference to FIG. 26B, the battery pack housing 586 may be provided with a plurality of, and particularly five, cylindrical battery cells 594 therein to form a battery pack 598. The cylindrical battery cells 594 may have a cell diameter of 46 mm, a cell length of 70 mm, a cell volume of 116,333.176 mm³, a cell capacity of 19.2 Ah, a cell ACIR of 21.1 mohm, and a cell DCIR of 51.5 mohm. The battery pack 598 may have a pack capacity of 19.2 Ah, an energy of 345 Wh, an energy density of 201 Wh/L, and a volumetric packing efficiency of 33.9%. Each cylindrical battery cell 594 within the battery pack 598 may be connected in series. A battery pack, such as the battery pack 598, may be defined by a number of groups (or, in other words, a number of “rows”) of battery cells that are connected in parallel. In the battery pack 598, since each cylindrical battery cell 594 is connected in series, the entire group of five battery cells 594 may be considered to be a single group or “row” of battery cells 594.

With reference to FIG. 26C, the battery pack housing 586 may be provided with a plurality of, and particularly ten, cylindrical battery cells 602 therein to form a battery pack 606. The cylindrical battery cells 602 may have a cell diameter of 35 mm, a cell length of 70 mm, a cell volume of 67,347.89251 mm³, a cell capacity of 11.1 Ah, a cell ACIR of 12.2 mohm, and a cell DCIR of 29.8 mohm. The battery pack 606 may have a pack capacity of 22.2 Ah, an energy of 400 Wh, an energy density of 233 Wh/L, and a volumetric packing efficiency of 39.3%. The battery pack 606 may include two groups (or “rows”) of battery cells 602 that are connected in parallel to each other, each row including five battery cells 602 connected in series, each battery cell 602 having a voltage of 3.6 volts.

With reference to FIG. 26D, the battery pack housing 586 may be provided with a plurality of, and particularly fifteen, cylindrical battery cells 610 therein to form a battery pack 614. The cylindrical battery cells 610 may have a cell diameter of 28 mm, a cell length of 70 mm, a cell volume of 43,102.65121 mm³, a cell capacity of 7.1 Ah, a cell ACIR of 7.8 mohm, and a cell DCIR of 19.1 mohm. The battery pack 614 may have a pack capacity of 21.3 Ah, an energy of 384 Wh, an energy density of 224 Wh/L, and a volumetric packing efficiency of 37.7%. The battery pack 614 may include three groups (or “rows”) of battery cells 610 that are connected in parallel to each other, each row including five battery cells 610 connected in series, each battery cell 610 having a voltage of 3.6 volts.

With reference to FIG. 26E, the battery pack housing 586 may be provided with a plurality of, and particularly twenty, cylindrical battery cells 618 therein to form a battery pack 622. The cylindrical battery cells 618 may have a cell diameter of 26 mm, a cell length of 70 mm, a cell volume of 37,165.04109 mm³, a cell capacity of 6.1 Ah, a cell ACIR of 6.7 mohm, and a cell DCIR of 16.4 mohm. The battery pack 622 may have a pack capacity of 24.5 Ah, an energy of 441 Wh, an energy density of 257 Wh/L, and a volumetric packing efficiency of 43.4%. The battery pack 622 may include four groups (or “rows”) of battery cells 618 that are connected in parallel to each other, each row including five battery cells 618 connected in series, each battery cell 618 having a voltage of 3.6 volts.

With reference to FIG. 26F, the battery pack housing 586 may be provided with a plurality of, and particularly twenty-five, cylindrical battery cells 626 therein to form a battery pack 630. The cylindrical battery cells 626 may have a cell diameter of 22 mm, a cell length of 70 mm, a cell volume of 26,609.28978 mm³, a cell capacity of 4.4 Ah, a cell ACIR of 4.8 mohm, and a cell DCIR of 11.8 mohm. The battery pack 630 may have a pack capacity of 22.0 Ah, an energy of 395 Wh, an energy density of 230 Wh/L, and a volumetric packing efficiency of 38.8%. The battery pack 630 may include five groups (or “rows”) of battery cells 626 that are connected in parallel to each other, each row including five battery cells 626 connected in series, each battery cell 626 having a voltage of 3.6 volts.

Certain features of the battery packs 598, 606, 614, 622, 630 are presented in the tables below:

TABLE 23-1

| | Cell | Cell Dia. | Cell Length | Cell Volume |
|---|---|---|---|---|
| Embodiment | Config. | (mm) | (mm) | (mm\hat{ }3) |
| Battery Pack 598 | 5S1P | 46 | 70 | 116333.176 |
| Battery Pack 606 | 5S2P | 35 | 70 | 67347.89251 |
| Battery Pack 614 | 5S3P | 28 | 70 | 43102.65121 |
| Battery Pack 622 | 5S4P | 26 | 70 | 37165.04109 |
| Battery Pack 630 | 5S5P | 22 | 70 | 26609.28978 |

TABLE 23-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 598 | 19.2 | 21.1 | 51.5 | 19.2 |
| Battery Pack 606 | 11.1 | 12.2 | 29.8 | 22.2 |
| Battery Pack 614 | 7.1 | 7.8 | 19.1 | 21.3 |
| Battery Pack 622 | 6.1 | 6.7 | 16.4 | 24.5 |
| Battery Pack 630 | 4.4 | 4.8 | 11.8 | 22.0 |

TABLE 23-3

| | | Energy Density | Vol. Packing |
|---|---|---|---|
| Embodiment | Energy (Wh) | (Wh/L) | Efficiency %: |
| Battery Pack 598 | 345 | 201 | 33.9 |
| Battery Pack 606 | 400 | 233 | 39.3 |
| Battery Pack 614 | 384 | 224 | 37.7 |
| Battery Pack 622 | 441 | 257 | 43.4 |
| Battery Pack 630 | 395 | 230 | 38.8 |

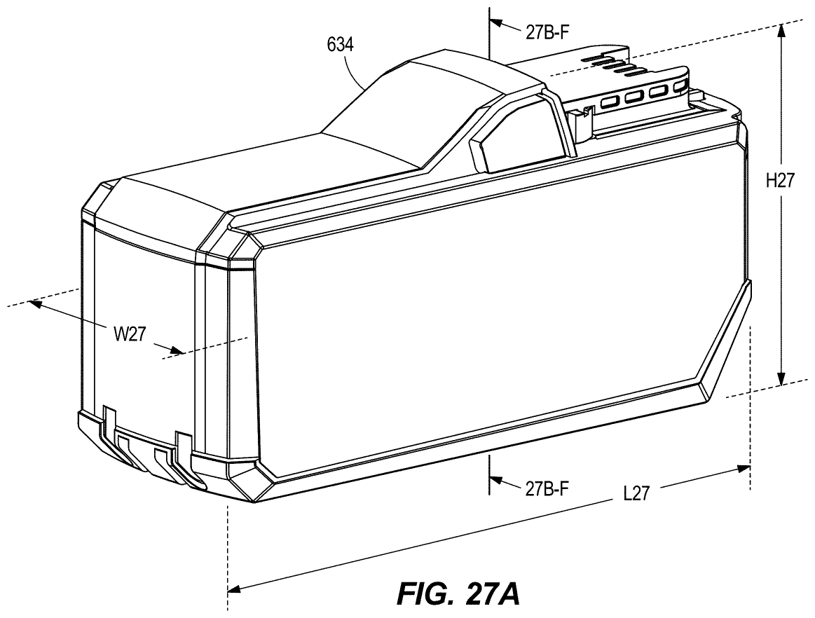

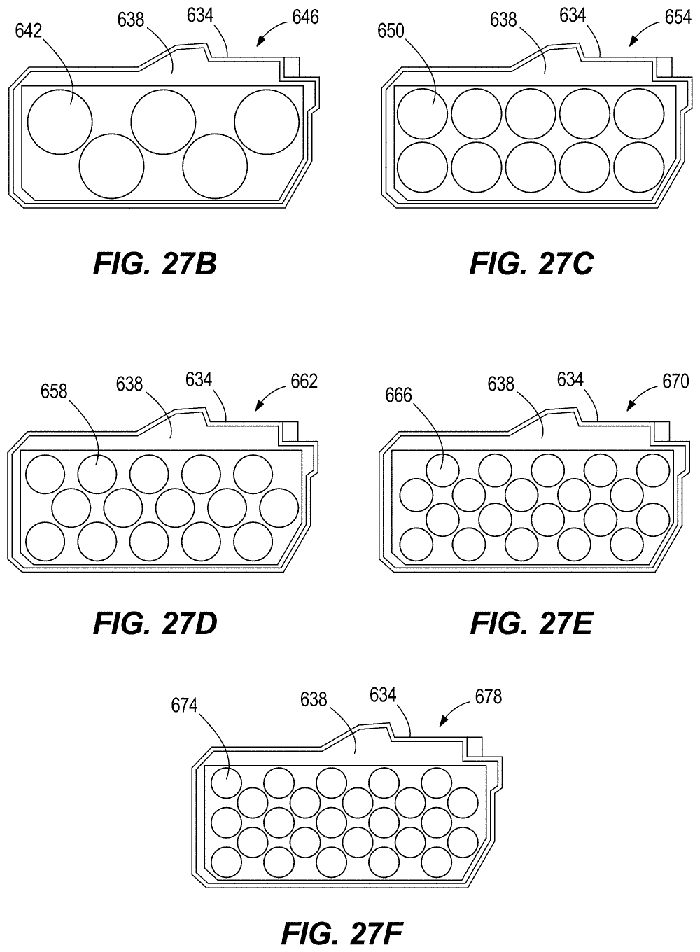

With reference to FIG. 27A, a battery pack housing 634 may have a length of 219.125 mm, a width of 86 mm, and a height of 117.2893 mm. The battery pack housing 634 may have an internal volume 638 of 1,753,566 mm³ (i.e., 1754 cm³ and 1.8 L). These dimensions of the battery pack housing 634 are listed in the following table:

TABLE 24

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 219.125 | 86 | 117.2893 | 1753566 | 1754 | 1.8 |

With reference to FIG. 27B, the battery pack housing 634 may be provided with a plurality of, and particularly five, cylindrical battery cells 642 therein to form a battery pack 646. The cylindrical battery cells 642 may have a cell diameter of 46 mm, a cell length of 70 mm, a cell volume of 116,333 mm³, a cell capacity of 19.2 Ah, a cell ACIR of 21.1 mohm, and a cell DCIR of 51.5 mohm. The battery pack 646 may have a pack capacity of 19.2 Ah, an energy of 345 Wh, an energy density of 197 Wh/L, and a volumetric packing efficiency of 33.2%. Each cylindrical battery cell 642 within the battery pack 646 may be connected in series. A battery pack, such as the battery pack 646, may be defined by a number of groups (or, in other words, a number of “rows”) of battery cells that are connected in parallel. In the battery pack 646, since each cylindrical battery cell 642 is connected in series, the entire group of five battery cells 642 may be considered to be a single group or “row” of battery cells 642.

With reference to FIG. 27C, the battery pack housing 634 may be provided with a plurality of, and particularly ten, cylindrical battery cells 650 therein to form a battery pack 654. The cylindrical battery cells 650 may have a cell diameter of 36 mm, a cell length of 70 mm, a cell volume of 71,251 mm³, a cell capacity of 11.8 Ah, a cell ACIR of 12.9 mohm, and a cell DCIR of 31.5 mohm. The battery pack 654 may have a pack capacity of 23.5 Ah, an energy of 423 Wh, an energy density of 241 Wh/L, and a volumetric packing efficiency of 40.6%. The battery pack 654 may include two groups (or “rows”) of battery cells 650 that are connected in parallel to each other, each row including five battery cells 650 connected in series, each battery cell 650 having a voltage of 3.6 volts.

With reference to FIG. 27D, the battery pack housing 634 may be provided with a plurality of, and particularly fifteen, cylindrical battery cells 658 therein to form a battery pack 662. The cylindrical battery cells 658 may have a cell diameter of 28 mm, a cell length of 70 mm, a cell volume of 43,103 mm³, a cell capacity of 7.1 Ah, a cell ACIR of 7.8 mohm, and a cell DCIR of 19.1 mohm. The battery pack 662 may have a pack capacity of 21.3 Ah, an energy of 384 Wh, an energy density of 219 Wh/L, and a volumetric packing efficiency of 36.9%. The battery pack 662 may include three groups (or “rows”) of battery cells 658 that are connected in parallel to each other, each row including five battery cells 658 connected in series, each battery cell 658 having a voltage of 3.6 volts.

With reference to FIG. 27E, the battery pack housing 634 may be provided with a plurality of, and particularly twenty, cylindrical battery cells 666 therein to form a battery pack 670. The cylindrical battery cells 666 may have a cell diameter of 24 mm, a cell length of 70 mm, a cell volume of 31,667 mm³, a cell capacity of 5.2 Ah, a cell ACIR of 5.7 mohm, and a cell DCIR of 14.0 mohm. The battery pack 670 may have a pack capacity of 20.9 Ah, an energy of 376 Wh, an energy density of 215 Wh/L, and a volumetric packing efficiency of 36.1%. The battery pack 670 may include four groups (or “rows”) of battery cells 666 that are connected in parallel to each other, each row including five battery cells 666 connected in series, each battery cell 666 having a voltage of 3.6 volts.

With reference to FIG. 27F, the battery pack housing 634 may be provided with a plurality of, and particularly twenty-five, cylindrical battery cells 674 therein to form a battery pack 678. The cylindrical battery cells 674 may have a cell diameter of 22 mm, a cell length of 70 mm, a cell volume of 26,609 mm³, a cell capacity of 4.4 Ah, a cell ACIR of 4.8 mohm, and a cell DCIR of 11.8 mohm. The battery pack 678 may have a pack capacity of 22.0 Ah, an energy of 395 Wh, an energy density of 225 Wh/L, and a volumetric packing efficiency of 37.9%. The battery pack 678 may include five groups (or “rows”) of battery cells 674 that are connected in parallel to each other, each row including five battery cells 674 connected in series, each battery cell 674 having a voltage of 3.6 volts.

Certain features of the battery packs 646, 654, 662, 670, 678 are presented in the tables below:

TABLE 25-1

| | Cell | Cell Dia. | Cell Length | Cell Volume |
|---|---|---|---|---|
| Embodiment | Config. | (mm) | (mm) | (mm\hat{ }3) |
| Battery Pack 646 | 5S1P | 46 | 70 | 116333 |
| Battery Pack 654 | 5S2P | 36 | 70 | 71251 |
| Battery Pack 662 | 5S3P | 28 | 70 | 43103 |
| Battery Pack 670 | 5S4P | 24 | 70 | 31667 |
| Battery Pack 678 | 5S5P | 22 | 70 | 26609 |

TABLE 25-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 646 | 19.2 | 21.1 | 51.5 | 19.2 |
| Battery Pack 654 | 11.8 | 12.9 | 31.5 | 23.5 |
| Battery Pack 662 | 7.1 | 7.8 | 19.1 | 21.3 |
| Battery Pack 670 | 5.2 | 5.7 | 14.0 | 20.9 |
| Battery Pack 678 | 4.4 | 4.8 | 11.8 | 22.0 |

TABLE 25-3

| | | Energy Density | Vol. Packing |
|---|---|---|---|
| Embodiment | Energy (Wh) | (Wh/L) | Efficiency %: |
| Battery Pack 646 | 345 | 197 | 33.2 |
| Battery Pack 654 | 423 | 241 | 40.6 |
| Battery Pack 662 | 384 | 219 | 36.9 |
| Battery Pack 670 | 376 | 215 | 36.1 |
| Battery Pack 678 | 395 | 225 | 37.9 |

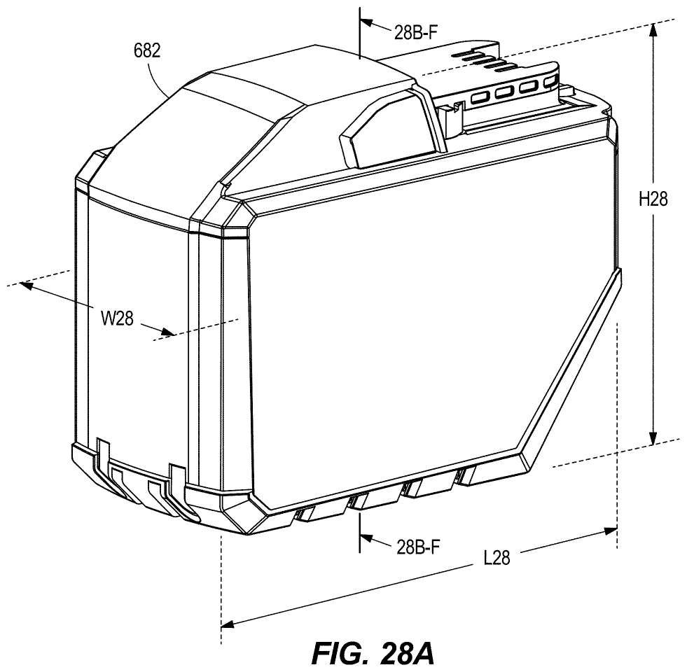

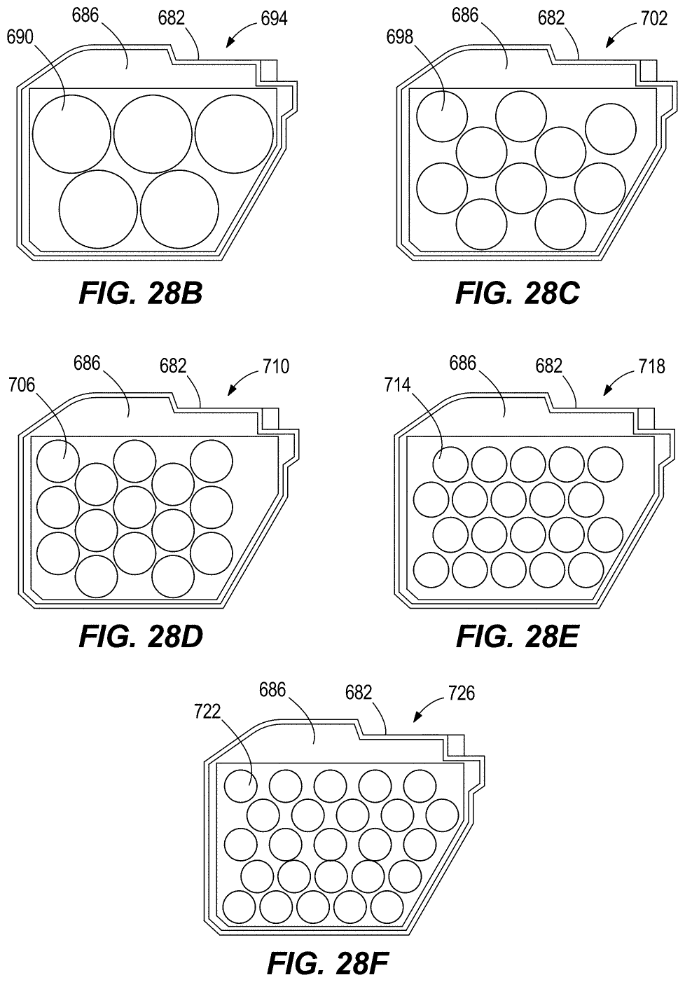

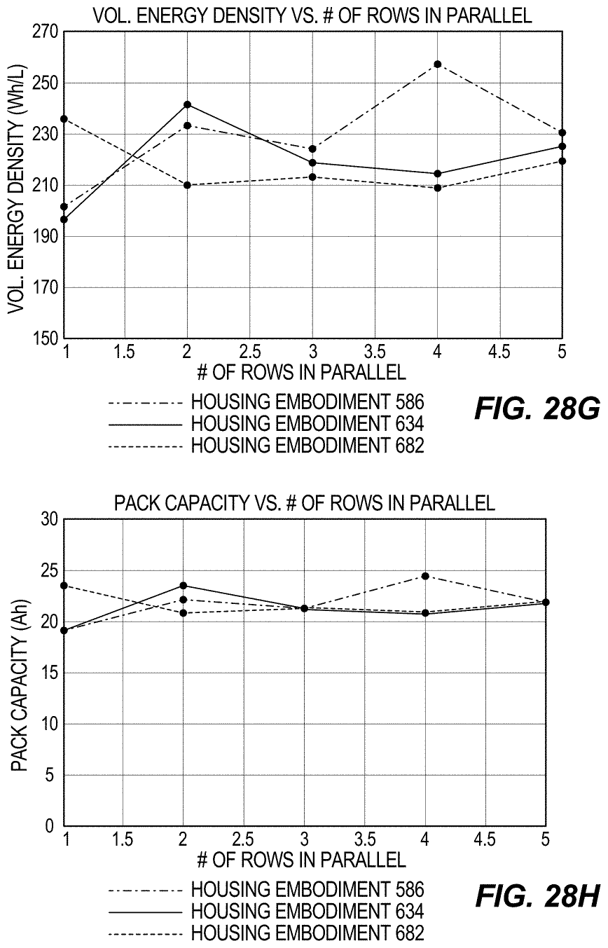

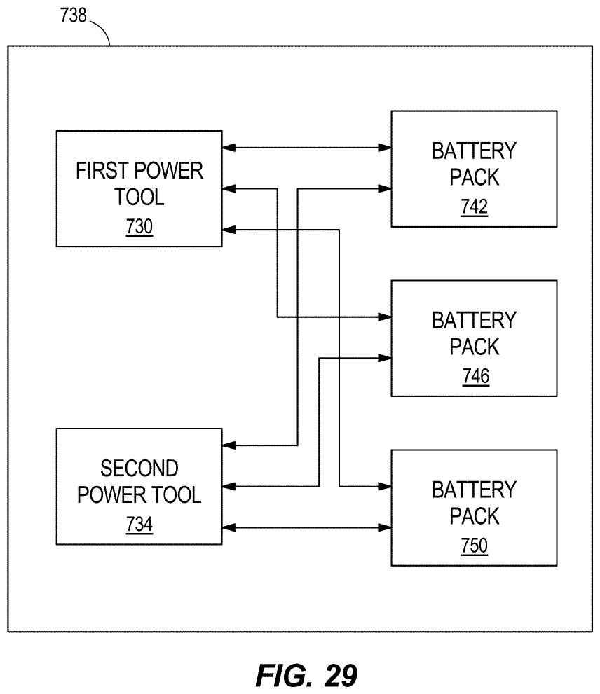

With reference to FIG. 28A, a battery pack housing 682 may have a length of 186.125 mm, a width of 86 mm, and a height of 143.6384 mm. The battery pack housing 682 may have an internal volume 686 of 1,799,466 mm³ (i.e., 1,799 cm³ and 1.8 L) (FIGS. 28B-28F). These dimensions of the battery pack housing 682 are listed in the following table:

TABLE 26

| LENGTH | WIDTH | HEIGHT | VOLUME | VOLUME | VOLUME |
|---|---|---|---|---|---|
| (MM) | (MM) | (MM) | (MM\hat{ }3) | (CM\hat{ }3) | (L) |
| 186.125 | 86 | 143.6384 | 1799466 | 1799 | 1.8 |

With reference to FIG. 28B, the battery pack housing 682 may be provided with a plurality of, and particularly five, cylindrical battery cells 690 therein to form a battery pack 694. The cylindrical battery cells 690 may have a cell diameter of 51 mm, a cell length of 70 mm, a cell volume of 142,997 mm³, a cell capacity of 23.6 Ah, a cell ACIR of 26.0 mohm, and a cell DCIR of 63.3 mohm. The battery pack 694 may have a pack capacity of 23.6 Ah, an energy of 425 Wh, an energy density of 236 Wh/L, and a volumetric packing efficiency of 39.73%. Each cylindrical battery cell 690 within the battery pack 694 may be connected in series. As otherwise mentioned herein, a battery pack, such as the battery pack 694, may be defined by a number of groups (or, in other words, a number of “rows”) of battery cells that are connected in parallel. In the battery pack 694, since each cylindrical battery cell 690 is connected in series, the entire group of five battery cells 690 may be considered to be a single group or “row” of battery cells 690.

With reference to FIG. 28C, the battery pack housing 682 may be provided with a plurality of, and particularly ten, cylindrical battery cells 698 therein to form a battery pack 702. The cylindrical battery cells 698 may have a cell diameter of 34 mm, a cell length of 70 mm, a cell volume of 63,554 mm³, a cell capacity of 10.5 Ah, a cell ACIR of 11.5 mohm, and a cell DCIR of 28.1 mohm. The battery pack 702 may have a pack capacity of 21.0 Ah, an energy of 377 Wh, an energy density of 210 Wh/L, and a volumetric packing efficiency of 35.32%. The battery pack 702 may include two groups (or “rows”) of battery cells 698 that are connected in parallel to each other, each row including five battery cells 698 connected in series, each battery cell 698 having a voltage of 3.6 volts.

With reference to FIG. 28D, the battery pack housing 682 may be provided with a plurality of, and particularly fifteen, cylindrical battery cells 706 therein to form a battery pack 710. The cylindrical battery cells 706 may have a cell diameter of 28 mm, a cell length of 70 mm, a cell volume of 43,103 mm³, a cell capacity of 7.1 Ah, a cell ACIR of 7.8 mohm, and a cell DCIR of 19.1 mohm. The battery pack 710 may have a pack capacity of 21.3 Ah, an energy of 384 Wh, an energy density of 213 Wh/L, and a volumetric packing efficiency of 35.93%. The battery pack 710 may include three groups (or “rows”) of battery cells 706 that are connected in parallel to each other, each row including five battery cells 706 connected in series, each battery cell 706 having a voltage of 3.6 volts.

With reference to FIG. 28E, the battery pack housing 682 may be provided with a plurality of, and particularly twenty, cylindrical battery cells 714 therein to form a battery pack 718. The cylindrical battery cells 714 may have a cell diameter of 24 mm, a cell length of 70 mm, a cell volume of 31,667 mm³, a cell capacity of 5.2 Ah, a cell ACIR of 5.7 mohm, and a cell DCIR of 14.0 mohm. The battery pack 718 may have a pack capacity of 20.9 Ah, an energy of 376 Wh, an energy density of 209 Wh/L, and a volumetric packing efficiency of 35.20%. The battery pack 718 may include four groups (or “rows”) of battery cells 714 that are connected in parallel to each other, each row including five battery cells 714 connected in series, each battery cell 714 having a voltage of 3.6 volts.

With reference to FIG. 28F, the battery pack housing 682 may be provided with a plurality of, and particularly twenty-five, cylindrical battery cells 722 therein to form a battery pack 726. The cylindrical battery cells 722 may have a cell diameter of 22 mm, a cell length of 70 mm, a cell volume of 26,609 mm³, a cell capacity of 4.4 Ah, a cell ACIR of 4.8 mohm, and a cell DCIR of 11.8 mohm. The battery pack 726 may have a pack capacity of 22.0 Ah, an energy of 395 Wh, an energy density of 220 Wh/L, and a volumetric packing efficiency of 36.97%. The battery pack 726 may include five groups (or “rows”) of battery cells 722 that are connected in parallel to each other, each row including five battery cells 722 connected in series, each battery cell 722 having a voltage of 3.6 volts.

Certain features of the battery packs 694, 702, 710, 718, 726 are presented in the tables below:

TABLE 27-1

| | Cell | Cell Dia. | Cell Length | Cell Volume |
|---|---|---|---|---|
| Embodiment | Config. | (mm) | (mm) | (mm\hat{ }3) |
| Battery Pack 694 | 5S1P | 51 | 70 | 142997 |
| Battery Pack 702 | 5S2P | 34 | 70 | 63554 |
| Battery Pack 710 | 5S3P | 28 | 70 | 43103 |
| Battery Pack 718 | 5S4P | 24 | 70 | 31667 |
| Battery Pack 726 | 5S5P | 22 | 70 | 26609 |

TABLE 27-2

| | | | | Pack |
|---|---|---|---|---|
| | Cell Capacity | Cell ACIR | Cell DCIR | Capacity |
| Embodiment | (Ah) | (mohm) | (mohm) | (Ah) |
| Battery Pack 694 | 23.6 | 26.0 | 63.3 | 23.6 |
| Battery Pack 702 | 10.5 | 11.5 | 28.1 | 21.0 |
| Battery Pack 710 | 7.1 | 7.8 | 19.1 | 21.3 |
| Battery Pack 718 | 5.2 | 5.7 | 14.0 | 20.9 |
| Battery Pack 726 | 4.4 | 4.8 | 11.8 | 22.0 |

TABLE 27-3

| | | Energy Density | Vol. Packing |
|---|---|---|---|
| Embodiment | Energy (Wh) | (Wh/L) | Efficiency %: |
| Battery Pack 694 | 425 | 236 | 39.73 |
| Battery Pack 702 | 377 | 210 | 35.32 |
| Battery Pack 710 | 384 | 213 | 35.93 |
| Battery Pack 718 | 376 | 209 | 35.20 |
| Battery Pack 726 | 395 | 220 | 36.97 |

A summary of certain features of the battery packs 598, 606, 614, 622, 630, 646, 654, 662, 670, 678, 694, 702, 710, 718, 726 are presented in the table below:

TABLE 28

| | | | | | VOL. |
|---|---|---|---|---|---|
| | BATTERY | | # OF ROWS | PACK | ENERGY |
| HOUSING | PACK | 5S6P | IN | CAPACITY | DENSITY |
| EMBODIMENT | EMBODIMENT | CONFIGURATIONS: | PARALLEL: | (AH) | (WH/L): |
| 586 | 598 | 5S1P | 1 | 19.2 | 201 |
| | 606 | 5S2P | 2 | 22.2 | 233 |
| | 614 | 5S3P | 3 | 21.3 | 224 |
| | 622 | 5S4P | 4 | 24.5 | 257 |
| | 630 | 5S5P | 5 | 22.0 | 230 |
| 634 | 646 | 5S1P | 1 | 19.2 | 197 |
| | 654 | 5S2P | 2 | 23.5 | 241 |
| | 662 | 5S3P | 3 | 21.3 | 219 |
| | 670 | 5S4P | 4 | 20.9 | 215 |
| | 678 | 5S5P | 5 | 22.0 | 225 |
| 682 | 694 | 5S1P | 1 | 23.6 | 236 |
| | 702 | 5S2P | 2 | 21.0 | 210 |
| | 710 | 5S3P | 3 | 21.3 | 213 |
| | 718 | 5S4P | 4 | 20.9 | 209 |
| | 726 | 5S5P | 5 | 22.0 | 220 |

With reference to FIG. 28G, volumetric energy density is plotted as a function of the number of rows of battery cells in parallel for the various disclosed embodiments of battery packs for the battery pack housings 586, 634, 682.

With reference to FIG. 28H, a pack capacity is plotted as a function of the number of rows of battery cells in parallel for the various disclosed embodiments of battery packs for the battery pack housings 586, 634, 682.

A method for selecting a battery pack housing along with battery cells to be placed therein includes (1) proposing a number of possible battery pack housing dimensions, (2) proposing a number of battery cell dimensions, (3) calculating a battery pack energy, a battery pack capacity, a volumetric energy density, and/or a volumetric packing efficiency for different combinations of the proposed battery pack housing dimensions and battery cell dimensions, and (4) selecting a battery pack housing and battery cells to be placed therein by maximizing one or more of the battery pack energy, the battery pack capacity, the volumetric energy density, and/or the volumetric packing efficiency.

With reference to FIG. 29, a first power tool 730 may be selectively alternatively couplable to a plurality of battery packs such as the battery packs 310, 318, 326, 334, 342, 358, 366, 374, 382, 390, 406, 414, 422, 430, 438, 454, 462, 470, 478, 486, 502, 510, 518, 526, 534, 550, 558, 566, 574, 582, 598, 606, 614, 622, 630, 646, 654, 662, 670, 678, 694, 702, 710, 718, 726. A second power tool 734 may also be selectively alternatively couplable to a plurality of battery packs such as the battery packs 310, 318, 326, 334, 342, 358, 366, 374, 382, 390, 406, 414, 422, 430, 438, 454, 462, 470, 478, 486, 502, 510, 518, 526, 534, 550, 558, 566, 574, 582, 598, 606, 614, 622, 630, 646, 654, 662, 670, 678, 694, 702, 710, 718, 726. The battery packs 310, 318, 326, 334, 342, 358, 366, 374, 382, 390, 406, 414, 422, 430, 438, 454, 462, 470, 478, 486, 502, 510, 518, 526, 534, 550, 558, 566, 574, 582, 598, 606, 614, 622, 630, 646, 654, 662, 670, 678, 694, 702, 710, 718, 726 may each have different shapes (i.e., form factors). In other words, a power tool system 738 may include the first power tool 730 and the second power tool 734. The power tool system 738 may further include that the power tools 730, 734 are couplable to a first battery pack such as, for example, the battery pack 310, a second battery pack such as, for example, the battery pack 358, and a third battery pack such as, for example, the battery pack 406. Many combinations of battery packs and power tools are contemplated herein such as, for example, any of the battery packs 310, 318, 326, 334, 342, 358, 366, 374, 382, 390, 406, 414, 422, 430, 438, 454, 462, 470, 478, 486, 502, 510, 518, 526, 534, 550, 558, 566, 574, 582, 598, 606, 614, 622, 630, 646, 654, 662, 670, 678, 694, 702, 710, 718, 726 with any power tools in the power tool system 738. In other words, the first power tool 730 may be selectively alternatively couplable to a first battery pack 742 of a first form factor, a second battery pack 746 of a second form factor, and a third battery pack 750 of a third form factor. The second power tool 734 may be selectively alternatively couplable to the first battery pack 742, the second battery pack 746, and the third battery pack 750, and the battery packs 742, 746, 750. In some embodiments, a fourth battery pack of a fourth form factor and a fifth battery pack of a fifth form factor may be included in the power tool system 738 and may be selectively alternatively couplable to the power tools 730, 734.

Embodiment 1. A battery pack comprises an outer housing and a plurality of pouch cells arranged within the outer housing. Each of the plurality of pouch cells has a first cell end, a second cell end, and a cell side surface provided between the first cell end and the second cell end. The cell side surface includes a first face, a second face, and a third face. Each of the plurality of pouch cells has a thickness in a first direction extending between the first cell end and the second cell end and has a two-dimensional projection in a plane that is orthogonal to the first direction. At least one of the plurality of pouch cells has a two-dimensional projection that is both noncircular and nonrectangular. The plurality of pouch cells are arranged in a first stack, a second stack, and a third stack. The first stack has a first longitudinal axis, the second stack has a second longitudinal axis, and the third stack has a third longitudinal axis. The second longitudinal axis is parallel to the third longitudinal axis, and the first longitudinal axis is perpendicular to both the second longitudinal axis and the third longitudinal axis.

Embodiment 2. A battery pack may include a two-dimensional projection that defines an outer boundary of the cell side surface. Embodiment 2 may be combined with any embodiment such as Embodiment 1.

Embodiment 3. A battery pack may include a two-dimensional projection that has a plurality of flattened edges. Embodiment 3 may be combined with any embodiment such as Embodiment 2.

Embodiment 4. A battery pack may include pouch cells, and the pouch cells may each include a two-dimensional projection that is a trilobal shape. Embodiment 4 may be combined with any embodiment such as Embodiment 3.

Embodiment 5. In a battery pack, a plurality of the pouch cells may be arranged in at least one stack having a uniformly prismatic structure along the first direction. Embodiment 5 may be combined with any embodiment such as Embodiment 4.

Embodiment 6. In a battery pack including a plurality of pouch cells, each of the plurality of pouch cells may include a first tab and a second tab. Embodiment 6 may be combined with any embodiment such as Embodiment 5.

Embodiment 7. In a battery pack with a pouch cell having a first tab and a second tab, the first tab may be provided on the first face and the second tab may be provided on the second face. Embodiment 7 may be combined with any embodiment such as Embodiment 6.

Embodiment 8. In a battery pack having a cell side surface that includes a first face, a second face, and a third face, the third face may not include a tab. Embodiment 8 may be combined with any embodiment such as Embodiment 7.

Embodiment 9. In a battery pack, at least a portion of the outer housing may be configured to match the shape of the uniformly prismatic structure. Embodiment 9 may be combined with any embodiment such as Embodiment 5.

Embodiment 10. In a battery pack, the outer housing may include a male protrusion that is configured to be received within a female battery receptacle of a power tool. Embodiment 10 may be combined with any embodiment such as Embodiment 9.

Embodiment 11. A battery pack may include a first stack of pouch cells having a uniformly prismatic structure and a second stack of pouch cells having a uniformly prismatic structure. Each of the stacks may include a first stack face, a second stack face, and a third stack face. Each of the pouch cells in the first stack shares a first common longitudinal axis. Each of the pouch cells in the second stack shares a second common longitudinal axis. The stacks of pouch cells are oriented such that the shortest distance between the first common longitudinal axis and the second common longitudinal axis passes through one of the stack faces of the first stack and also passes through one of the stack faces of the second stack. Embodiment 11 may be combined with any embodiment such as Embodiment 5.

Embodiment 12. A battery pack may include a first pouch cell and a second pouch cell, each having a uniformly prismatic structure and a longitudinal axis. The longitudinal axis of the first pouch cell is parallel to the longitudinal axis of the second pouch cell. The pouch cells are oriented such that one of the faces of the first pouch cell is adjacent to one of the faces of the second pouch cell. Embodiment 12 may be combined with any embodiment such as Embodiment 4.

Embodiment 13. The battery pack may include a first pouch cell and a second pouch cell, each having a uniformly prismatic structure and a longitudinal axis. The pouch cells may be oriented such that the shortest distance between the longitudinal axes of the first pouch cell and the second pouch cell passes through one of the faces of the first pouch cell and also passes through one of the faces of the second pouch cell. Embodiment 13 may be combined with any embodiment such as Embodiment 4.

Embodiment 14. In a battery pack including pouch cells, each of the pouch cells may include a two-dimensional projection that includes at least five sides. Embodiment 14 may be combined with any embodiment such as Embodiment 3.

Embodiment 15. In a battery pack including pouch cells, each of the pouch cells may include a two-dimensional projection that includes at least six sides. Embodiment 15 may be combined with any embodiment such as Embodiment 3.

Embodiment 16. In a battery pack including pouch cells, each of the pouch cells may include a two-dimensional projection that includes at least seven sides. Embodiment 16 may be combined with any embodiment such as Embodiment 3.

Embodiment 17. A battery pack comprises a cylindrical pouch cell housed in a cell can having a longitudinal axis. The cell can may be formed as a first cell can piece and a second cell can piece. The first cell can piece may have a first cell can end and the second cell can piece may have a second cell can end. The first cell can piece may be crimped to the second cell can piece at a crimping location. The crimping location may be located between the first cell can end and the second cell can end. The crimping location may extend circumferentially around the cylindrical pouch cell and may be provided with a separator and a gasket.

Embodiment 18. In a battery pack having a cylindrical cell crimped at a crimping location, the crimping location may be at the center of the cell can as measured along the longitudinal axis of the cell can. Embodiment 18 may be combined with any embodiment such as Embodiment 17.

Embodiment 19. In a battery pack having a pouch cell housed in a cell can, the pouch cell may include tabs. The cell can may include at least one slot in one of the first cell can end and the second cell can end through which the tabs protrude. Embodiment 19 may be combined with any embodiment such as Embodiment 17.

Embodiment 20. A battery pack comprises a battery cell having an elongated prismatic structure. The battery cell includes a first end and a second end. One of the ends may have electrical connections. The battery cell may include a body portion disposed between the first end and the second end. The body portion may include a cell side surface that extends between the first end and the second end. The battery cell may include a longitudinal axis that extends between the first end and the second end. The cell side surface may include a plurality of flattened faces and may include a plurality of corners.

Embodiment 21. In a battery pack, a plurality of battery cells may be provided within the battery pack and arranged such that the shortest distance between the longitudinal axes of two adjacent battery cells passes through a face of each of the two adjacent battery cells. Embodiment 21 may be combined with any embodiment such as Embodiment 20.

The features of the embodiments disclosed herein may be mixed and matched between different embodiments. The battery cells disclosed herein may be pouch cells.

What is claimed is:

1. A power tool system comprising:
a first battery pack having a first plurality of cylindrical cells, each of the first plurality of cylindrical cells having first dimensions;
a second battery pack having a second plurality of cylindrical cells, each of the second plurality of cylindrical cells having second dimensions, at least one of the second dimensions being different from a corresponding one of the first dimensions;
a third battery pack having a third plurality of cylindrical cells, each of the third plurality of cylindrical cells having third dimensions, at least one of the third dimensions being different from a corresponding one of the first dimensions and a corresponding one of the second dimensions;
a fourth battery pack having a fourth plurality of pouch cells, each of the fourth plurality of pouch cells having fourth dimensions, at least one of the fourth dimensions being different from a corresponding one of the first dimensions, a corresponding one of the second dimensions, and a corresponding one of the third dimensions; and
wherein the first battery pack, the second battery pack, the third battery pack, and the fourth battery pack are exchangeably couplable to a power tool.

2. The power tool system of claim 1, wherein each cell of each of the first, second, and third pluralities of cylindrical cells has a diameter of between 15 mm and 55 mm.

3. The power tool system of claim 2, wherein each cell of each of the first, second, and third pluralities of cylindrical cells has a length of between 60 mm and 80 mm.

4. The power tool system of claim 3, wherein each cell of each of the first, second, and third pluralities of cylindrical cells has an energy density of at least 580 Wh/L.

5. The power tool system of claim 1, wherein
the first battery pack has a first interior volume,
the second battery pack has a second interior volume different from the first interior volume,
the third battery pack has a third interior volume different from the first interior volume and the second interior volume, and
the fourth battery pack has a fourth interior volume different from the first interior volume, the second interior volume, and the third interior volume.

6. The power tool system of claim 1, wherein each cell of the first plurality of cylindrical cells has a diameter of 18 mm and a length of 65 mm.

7. The power tool system of claim 6, wherein each cell of the second plurality of cylindrical cells has a diameter of 21 mm and a length of 70 mm.

8. The power tool system of claim 1, wherein
the first battery pack has a first shape,
the second battery pack has a second shape,
the third battery pack has a third shape, and
the first shape, the second shape, and the third shape are different from each other.

9. The power tool system of claim 1, wherein a length of each of the first battery pack, the second battery pack, the third battery pack, and the fourth battery pack is different from the length of each of the other battery packs.

10. The power tool system of claim 1, wherein a height of each of the first battery pack, the second battery pack, the third battery pack, and the fourth battery pack is different from the height of each of the other battery packs.

11. The power tool system of claim 1, wherein each of the first battery pack, the second battery pack, the third battery pack, and the fourth battery pack has a different battery pack capacity.

12. The power tool system of claim 1, wherein each of the first battery pack, the second battery pack, the third battery pack, and the fourth battery pack has a different energy density.

13. A power tool system comprising:
a first battery pack having
a first battery connection interface couplable to a power tool, and
a first plurality of cylindrical cells of a first type;
a second battery pack having
a second battery connection interface couplable to the power tool, and
a second plurality of cylindrical cells of a second type, the second type being different from the first type; and
a third battery pack having
a third battery connection interface couplable to the power tool, and
a third plurality of cylindrical cells of a third type, the third type being different from the first type and the second type.

14. The power tool system of claim 13, wherein the first battery connection interface, the second connection interface, and the third connection interface are identical.

15. The power tool system of claim 13, wherein
each of the first type, second type, and third type includes a diameter, and
a diameter of each of the first, second, and third pluralities of cylindrical cells is between 15 mm and 55 mm.

16. The power tool system of claim 13, wherein
each of the first type, second type, and third type includes a length, and
a length of each of the first, second, and third pluralities of cylindrical cells is between 60 mm and 80 mm.

17. The power tool system of claim 13, wherein
the first battery pack has a first battery pack capacity,
the second battery pack has a second battery pack capacity that is different from the first battery pack capacity, and
the third battery pack has a third battery pack capacity that is different from the first battery pack capacity and the second battery pack capacity.

18. The power tool system of claim 13, wherein
the first battery pack has a first battery pack energy density,
the second battery pack has a second battery pack energy density that is different from the first battery pack energy density, and
the third battery pack has a third battery pack energy density that is different from the first battery pack energy density and the second battery pack energy density.

19. The power tool system of claim 13, wherein each of the first battery pack energy density, the second battery pack energy density, and the third battery pack energy density is at least 185 Wh/L.

20. A battery pack comprising:
a battery pack housing having an internal volume defined therein;
a plurality of cylindrical battery cells disposed in the internal volume and electrically connected to each other to provide power to a power tool; and
wherein the battery pack has a battery pack energy density of at least 213 Wh/L.

21. The battery pack of claim 20, wherein the battery pack has an energy density of at least 222 Wh/L.

22. The battery pack of claim 21, wherein the battery pack has an energy density of at least 241 Wh/L.

23. The battery pack of claim 22, wherein the battery pack has an energy density of at least 250 Wh/L.

24. The battery pack of claim 23, wherein the battery pack has an energy density of at least 257 Wh/L.
